(19) United States
(12) Patent Application Publication
(10) Pub. No.: US 2026/0282095 A1
(43) Pub. Date: Sep. 17, 2026

(54) TECHNIQUES FOR RANDOM ACCESS IN WIRELESS COMMUNICATIONS

(71) Applicant: QUALCOMM Incorporated, San Diego, CA (US)

(72) Inventors: Jing LEI, San Diego, CA (US); Jing SUN, San Diego, CA (US); Weimin DUAN, San Diego, CA (US); Kangqi LIU, San Diego, CA (US)

(21) Appl. No.: 19/077,752

(22) Filed: Mar. 12, 2025

(51) Int. Cl. H04W 74/0833

(52) U.S. Cl. CPC H04W 74/0833

(57) ABSTRACT

Methods, systems, and devices for wireless communications are described in which a user equipment (UE) may provide an indication of one or more associated features in a random access procedure. The UE may transmit a random access request to a network entity, which may receive the random access request and transmit a random access response. The network entity may support early identification of UE features, and the UE may indicate a feature combination in a subsequent uplink message. If an uplink grant provided in the random access response provides sufficient resources the UE may provide the indication of features using associated uplink resources provided in the uplink grant. If the uplink grant provided in the random access response does not provide sufficient resources, the UE may transmit a scheduling request to request a different uplink grant with sufficient resource to provide the indication of features of the UE.

### FIELD OF TECHNOLOGY

The following relates to wireless communications, including techniques for random access in wireless communications.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include transmitting a random access request to a network entity, receiving a random access response that provides an indication of uplink grant for an uplink message subsequent to the random access request, the uplink grant including at least a first uplink resource for a random access message and a second uplink resource for a scheduling request, selecting an uplink transmission resource for the uplink message from the first uplink resource or the second uplink resource, the uplink message including the random access message or the scheduling request in accordance with the selected uplink transmission resource, and transmitting the uplink message via the selected uplink transmission resource.

A UE for wireless communications is described. The UE may include one or more memories storing processor executable code, and one or more processors coupled with the one or more memories. The one or more processors may individually or collectively be operable to execute the code to cause the UE to transmit a random access request to a network entity, receive a random access response that provides an indication of uplink grant for an uplink message subsequent to the random access request, the uplink grant including at least a first uplink resource for a random access message and a second uplink resource for a scheduling request, select an uplink transmission resource for the uplink message from the first uplink resource or the second uplink resource, the uplink message including the random access message or the scheduling request in accordance with the selected uplink transmission resource, and transmit the uplink message via the selected uplink transmission resource.

Another UE for wireless communications is described. The UE may include means for transmitting a random access request to a network entity, means for receiving a random access response that provides an indication of uplink grant for an uplink message subsequent to the random access request, the uplink grant including at least a first uplink resource for a random access message and a second uplink resource for a scheduling request, means for selecting an uplink transmission resource for the uplink message from the first uplink resource or the second uplink resource, the uplink message including the random access message or the scheduling request in accordance with the selected uplink transmission resource, and means for transmitting the uplink message via the selected uplink transmission resource.

A non-transitory computer-readable medium storing code for wireless communications is described. The code may include instructions executable by one or more processors to transmit a random access request to a network entity, receive a random access response that provides an indication of uplink grant for an uplink message subsequent to the random access request, the uplink grant including at least a first uplink resource for a random access message and a second uplink resource for a scheduling request, select an uplink transmission resource for the uplink message from the first uplink resource or the second uplink resource, the uplink message including the random access message or the scheduling request in accordance with the selected uplink transmission resource, and transmit the uplink message via the selected uplink transmission resource.

In some examples of the method, UEs, and non-transitory computer-readable medium described herein, the selected uplink transmission resource is for the random access message when the first uplink resource for the random access message provides sufficient uplink resources to indicate one or more features that are supported by the UE.

Some examples of the method, UEs, and non-transitory computer-readable medium described herein may further include operations, features, means, or instructions for determining the first uplink resource for the random access message is invalid for transmission of the random access message and transmitting the scheduling request via the second uplink resource for the scheduling request, where the scheduling request indicates a request for a valid uplink grant for transmission of the random access message.

In some examples of the method, UEs, and non-transitory computer-readable medium described herein, transmitting the uplink message may include operations, features, means, or instructions for adapting the first uplink resource for the random access message to provide an indication of one or more features that are supported by the UE and transmitting the uplink message via the adapted first uplink resource. In some examples of the method, UEs, and non-transitory computer-readable medium described herein, and the method, apparatuses, and non-transitory computer-readable medium may include further operations, features, means, or instructions for adapting a waveform for the random access message to be transmitted via the first uplink resource, puncturing one or more resource blocks of the first uplink resource, and puncturing one or more symbols of the first uplink resource.

Some examples of the method, UEs, and non-transitory computer-readable medium described herein may further include operations, features, means, or instructions for receiving control information that indicates the second uplink resource for the scheduling request is provided in the random access response, the first uplink resource is modifiable to provide an indication of one or more features that are supported by the UE, or any combination thereof. In some examples of the method, UEs, and non-transitory computer-readable medium described herein, the control information may be provided in one or more of system information, radio resource control signaling, or the random access response. In some examples of the method, UEs, and non-transitory computer-readable medium described herein, the control information indicates one or more of a resource configuration for a scheduling request message associated with the second uplink resource, or one or more thresholds associated with selection of the first uplink resource or the second uplink resource for the uplink message. In some examples of the method, UEs, and non-transitory computer-readable medium described herein, the control information indicates one or more adaptations available for the first uplink resource for transmission of the random access message, or one or more thresholds associated with selection of the first uplink resource or the second uplink resource for the uplink message, or any combination thereof.

In some examples of the method, UEs, and non-transitory computer-readable medium described herein, the uplink message includes the scheduling request and the uplink grant indicates control channel resources, and where the scheduling request includes a payload that indicates a type of grant that is requested by the UE or an identification associated with the UE. In some examples of the method, UEs, and non-transitory computer-readable medium described herein, the uplink message includes the scheduling request that is transmitted using a waveform selected from a set of available waveforms that indicates one or more features associated with a type of grant that is requested by the UE.

In some examples of the method, UEs, and non-transitory computer-readable medium described herein, the random access response further indicates a timing advance value that is applied for transmission of the uplink message.

In some examples of the method, UEs, and non-transitory computer-readable medium described herein, the random access response further indicates the second uplink resource is active in accordance with one of a control information field of a control channel associated with the random access response, a medium access control (MAC) header field associated with a backoff indication, a MAC header field associated with a random access preamble identifier of the random access request, or an information field within the random access response.

In some examples of the method, UEs, and non-transitory computer-readable medium described herein, the random access response further indicates a timing offset associated with the second uplink resource, and where the timing offset is provided in a joint indication of a control channel and a shared channel associated with the random access response, or the timing offset is provided only in the shared channel associated with the random access response. In some examples of the method, UEs, and non-transitory computer-readable medium described herein, the timing offset is between a last symbol of a shared channel associated with the random access response and an initial symbol of the second uplink resource, and corresponds to a time gap associated with a timing advance and a waveform preparation time associated with transmission of the scheduling request.

Some examples of the method, UEs, and non-transitory computer-readable medium described herein may further include operations, features, means, or instructions for initiating a timer responsive to transmission of the scheduling request via the second uplink resource, the timer providing a time window for monitoring for a subsequent uplink grant associated with the scheduling request.

In some examples of the method, UEs, and non-transitory computer-readable medium described herein, the indication of the uplink grant in the random access response indicates an ordered random access channel resource for early indication of multiple UE types.

A method for wireless communications by a network entity is described. The method may include receiving a random access request from a UE, transmitting, to the UE, a random access response that provides an indication of an uplink grant for an uplink message subsequent to the random access request, the uplink grant including at least a first uplink resource for a random access message and a second uplink resource for a scheduling request, and monitoring the first uplink resource for the random access message and the second uplink resource for the scheduling request.

A network entity for wireless communications is described. The network entity may include one or more memories storing processor executable code, and one or more processors coupled with the one or more memories. The one or more processors may individually or collectively be operable to execute the code to cause the network entity to receive a random access request from a UE, transmit, to the UE, a random access response that provides an indication of an uplink grant for an uplink message subsequent to the random access request, the uplink grant including at least a first uplink resource for a random access message and a second uplink resource for a scheduling request, and monitor the first uplink resource for the random access message and the second uplink resource for the scheduling request.

Another network entity for wireless communications is described. The network entity may include means for receiving a random access request from a UE, means for transmitting, to the UE, a random access response that provides an indication of an uplink grant for an uplink message subsequent to the random access request, the uplink grant including at least a first uplink resource for a random access message and a second uplink resource for a scheduling request, and means for monitoring the first uplink resource for the random access message and the second uplink resource for the scheduling request.

A non-transitory computer-readable medium storing code for wireless communications is described. The code may include instructions executable by one or more processors to receive a random access request from a UE, transmit, to the UE, a random access response that provides an indication of an uplink grant for an uplink message subsequent to the random access request, the uplink grant including at least a first uplink resource for a random access message and a second uplink resource for a scheduling request, and monitor the first uplink resource for the random access message and the second uplink resource for the scheduling request.

In some examples of the method, network entities, and non-transitory computer-readable medium described herein, the uplink message is received via the first uplink resource when the first uplink resource provides sufficient uplink resources for the UE to indicate one or more features that are supported by the UE.

Some examples of the method, network entities, and non-transitory computer-readable medium described herein may further include operations, features, means, or instructions for receiving the scheduling request via the second uplink resource, the scheduling request indicating a request for a subsequent uplink grant with sufficient resources for the UE to indicate one or more features that are supported by the UE.

Some examples of the method, network entities, and non-transitory computer-readable medium described herein may further include operations, features, means, or instructions for receiving the random access message via the first uplink resource, where the first uplink resource is adapted to provide an indication of one or more features that are supported by the UE.

In some examples of the method, network entities, and non-transitory computer-readable medium described herein, an adapted waveform for the random access message transmitted via the first uplink resource, one or more punctured resource blocks of the first uplink resource, and one or more punctured symbols of the first uplink resource.

Some examples of the method, network entities, and non-transitory computer-readable medium described herein may further include operations, features, means, or instructions for transmitting control information that indicates the second uplink resource is provided in the random access response, the first uplink resource is modifiable to provide an indication of one or more features that are supported by the UE, or any combination thereof. In some examples of the method, network entities, and non-transitory computer-readable medium described herein, the control information may be provided in one or more of system information, radio resource control signaling, or the random access response. In some examples of the method, network entities, and non-transitory computer-readable medium described herein, the control information indicates one or more of a resource configuration for the scheduling request associated with the second uplink resource, or one or more thresholds associated with selection of the first uplink resource or the second uplink resource for the uplink message. In some examples of the method, network entities, and non-transitory computer-readable medium described herein, the control information indicates one or more adaptations available for the second uplink resource for transmission of the random access message, or one or more thresholds associated with selection of the first uplink resource or the second uplink resource for the uplink message, or any combination thereof.

In some examples of the method, network entities, and non-transitory computer-readable medium described herein, the uplink message includes the scheduling request and the uplink grant indicates control channel resources, and where the scheduling request includes a payload that indicates a type of grant that is requested by the UE or an identification associated with the UE.

In some examples of the method, network entities, and non-transitory computer-readable medium described herein, the uplink message includes the scheduling request that is transmitted using a waveform selected from a set of available waveforms that indicates one or more features associated with a type of grant that is requested by the UE.

In some examples of the method, network entities, and non-transitory computer-readable medium described herein, the random access response further indicates a timing advance value that is to be applied for transmission of the uplink message.

In some examples of the method, network entities, and non-transitory computer-readable medium described herein, the random access response further indicates the second uplink resource may be active in accordance with one of a control information field of a control channel associated with the random access response, a MAC header field associated with a backoff indication, a MAC header field associated with a random access preamble identifier of the random access request, or an information field within the random access response.

In some examples of the method, network entities, and non-transitory computer-readable medium described herein, the random access response further indicates a timing offset associated with the second uplink resource, and where the timing offset is provided in a joint indication of a control channel and a shared channel associated with the random access response, or the timing offset is provided only in the shared channel associated with the random access response. In some examples of the method, network entities, and non-transitory computer-readable medium described herein, the timing offset is between a last symbol of a shared channel associated with the random access response and an initial symbol of the second uplink resource, and corresponds to a time gap associated with a timing advance and a waveform preparation time associated with transmission of the scheduling request.

In some examples of the method, network entities, and non-transitory computer-readable medium described herein, the indication of the uplink grant in the random access response indicates an ordered random access channel resource for early indication of multiple UE types.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports techniques for random access in wireless communications in accordance with one or more aspects of the present disclosure.

FIG. 2 shows an example of a wireless communications system that supports techniques for random access in wireless communications.

FIG. 3 shows an example of a process flow that supports techniques for random access in wireless communications.

FIG. 4 shows an example of medium access control messages that support techniques for random access in wireless communications.

FIGS. 5 and 6 show block diagrams of devices that support techniques for random access in wireless communications.

FIG. 7 shows a block diagram of a communications manager that supports techniques for random access in wireless communications.

FIG. 8 shows a diagram of a system including a device that supports techniques for random access in wireless communications.

FIGS. 9 and 10 show block diagrams of devices that support techniques for random access in wireless communications.

FIG. 11 shows a block diagram of a communications manager that supports techniques for random access in wireless communications.

FIG. 12 shows a diagram of a system including a device that supports techniques for random access in wireless communications.

FIGS. 13 through 16 show flowcharts illustrating methods that support techniques for random access in wireless communications.

### DETAILED DESCRIPTION

Some wireless communications system may deploy a network entity and a user equipment (UE). The UE may perform a random access procedure in order to gain network access via the network entity. In some approaches, the network entity may transmit synchronization signals, such as a synchronization signal blocks (SSBs) associated with different beams, and monitor random access channel (RACH) occasions for random access preambles from one or multiple UEs. In some cases, a network entity may configure partitioned RACH resources, and a UE may select a particular partition for a RACH message to facilitate early identification of one or more UE capabilities, such as a payload size for a RACH response that is supported by the UE, a type of random access procedure supported by the UE, a system information (SI) request, one or more UE capabilities, and/or other feature combinations or prioritizations. To enable such early identification based on a random access request message (e.g., a MSG1 transmission in a contention-based RACH procedure), the network entity may split physical random access channel (PRACH) resources (e.g., PRACH occasions or preambles) into orthogonal sets (e.g., in time/frequency/code domains) and broadcast the configurations in SI. As the number of feature combinations increase, the network entity may need to allocate more resources for PRACH to mitigate collision probability, which may increase the system overhead and processing complexity and also may reduce a trunking efficiency of PRACH. Further, relatively few UEs, or no UEs, may use one or more of the partitions for a given set of PRACH resources, which may result in unused resources and reduce system efficiency. Thus, techniques to provide for early identification of UE capabilities which enhance network efficiency may be desirable.

In some deployments, in order to avoid inefficiencies of partitioned PRACH resources, a network entity may not provide such a configuration. However, in such cases where PRACH-based early identification is not configured or enabled, a UE may receive an uplink grant (e.g., in a random access response message or a MSG2 transmission of the RACH procedure) that is invalid or inappropriate for a subsequent uplink transmission (e.g., a MSG3 transmission in the RACH procedure) that is based on the uplink grant. For example, a UE at cell edge may receive an uplink grant that does not schedule repetitions or frequency hopping for a MSG3 transmission, which may be a coverage bottleneck, such that a reliability of the MSG3 transmission is reduced. In another example, a UE with reduced capabilities (e.g., reduced processing capabilities or a UE with lower complexity RF components that supports a relatively narrow bandwidth for communications) may receive an uplink grant that schedules an uplink transmission (e.g., a MSG3 transmission) outside of its initial uplink bandwidth part (BWP), and thus the uplink grant is invalid for the UE. In a further example, a UE intending to access a network slice for a mission critical service may receive an uplink grant that is too small to carry the uplink payload of the UE. In cases where the UE skips the uplink transmission due to an invalid or inappropriate uplink grant, the network entity may be unaware of the situation and may re-send the uplink grant, which will be ignored again by the UE, leading to increased latency and power consumption. Additionally, in some systems, a UE performing a random access procedure may re-attempt the RACH procedure if its uplink transmission or re-transmissions (e.g., MSG3 transmissions) fail. To re-attempt the RACH procedure, the UE may retransmit the random access request message (e.g., MSG1) with power ramping, or select a different RACH preamble, and before such a retransmission or RACH resource re-selection, the UE may have already spent a long time monitoring for a further RACH message (e.g., a contention resolution message or MSG4) before an associated timer expires (e.g., a contention resolution timer). Thus, such techniques may result in a relatively long latency before successful completion of random access, and power consumption of the UE may be increased with multiple rounds of RACH procedure attempts and re-attempts. Thus, efficient techniques for random access for UEs having different capabilities and situations may be desirable.

In accordance with various aspects discussed herein, enhanced random access techniques may provide for efficient use of PRACH resources while providing reliable indication of UE features with relatively low latency. Techniques as discussed herein may be implemented in both regular or standard capability UEs, as well as low-tier or lower-complexity UEs that support random access-based early identification. In some aspects, a random access response from a network entity (e.g., transmitted in response to a random access request from a UE) selectively may provide an indication of a scheduling request resource that may be used by the UE to request an uplink grant associated with a random access procedure that is being performed by the UE. In some aspects, the network entity may provide an indication of the scheduling request resource in a random access response when the ransom access response indicates an uplink grant for a subsequent uplink transmission that may be incompatible for one or more UEs (e.g., when the uplink grant indicates frequency resources that span a larger bandwidth than some UEs may support, if a timing offset between the random access response and the subsequent uplink message is less than the processing gap required by lower tier UEs, or if a grant size if the uplink grant is not sufficient for cell-edge UEs or for transmission of a payload of a UE). In some aspects, if a UE receives an uplink grant in a random access response that has invalid or inappropriate parameters for the subsequent random access message from the UE (e.g., a MSG3 transmission), and that also includes the scheduling request resource indication, the UE may use the scheduling request resource to request a valid UL grant for the subsequent uplink random access message (e.g., MSG3). In some aspects, for overhead reduction, the scheduling request may be transmitted on a physical uplink control channel (PUCCH) resource associated with the random access procedure (e.g., re-using “pucch-ResourceCommon” resource configured for idle/inactive UEs). In some aspects, to accommodate the scheduling request resource indication, the random access response (e.g., MSG2, which may be transmitted on a physical downlink control channel (PDCCH) or physical downlink shared channel (PDSCH)), may include a bit field that indicates the scheduling request resource.

In some aspects, a UE may transmit a random access request to a network entity, such as a RACH message-1 (MSG1) of a contention-based random access (CBRA) procedure. A network entity may receive the random access request and transmit a random access response. In some aspects, if a network entity supports early identification of UE during CBRA, but does not configure a dedicated PRACH resource pool for the supported UE feature(s), the UE may adopt one of multiple techniques to facilitate early identification in RRC idle/inactive state. In some cases, the UE may indicate the feature combination in an uplink random access message (e.g., MSG3) if the uplink grant in a random access response provides sufficient resources indication of associated features for early identification. In some cases, if the uplink grant is not valid for early identification (e.g., provides insufficient uplink resources) the UE may transmit a scheduling request to the network entity and request a new uplink grant that is valid for indication of the early identification features of the UE. In further cases, additionally or alternatively, the UE may indicate the feature combination in the uplink random access message (e.g., MSG3) after performing an uplink grant adaptation, if the uplink grant in the random access response is invalid and the UE is capable of adapting the uplink grant (such as adaptation of a waveform associated with the uplink grant, puncturing one or more resource blocks (RBs) or symbols associated with the uplink grant, or any combination thereof). In some aspects, one or more criteria or thresholds for uplink grant validation may be separately configured by the network, and the UE may select a response based on such a configuration. In some aspects, the network entity may configure a scheduling request indication, uplink grant adaptation, or both, in system information (SI), radio resource control (RRC) signaling, in the random access response, or any combination thereof. In some aspects, activation or deactivation of such techniques, and a scheduling request resource indication, may be dynamically signaled in the random access response. Accordingly, overhead associated with PRACH resources for systems that support early indication of UE features may be reduced, while also reducing power consumption at one or more UEs and supporting effective random access operations and maintaining communications reliability, quality, and latency targets.

Aspects of the disclosure are initially described in the context of wireless communications systems. Aspects of the disclosure are further illustrated by and described with reference to process flows, MAC payload examples, apparatus diagrams, system diagrams, and flowcharts that relate to techniques for random access in wireless communications.

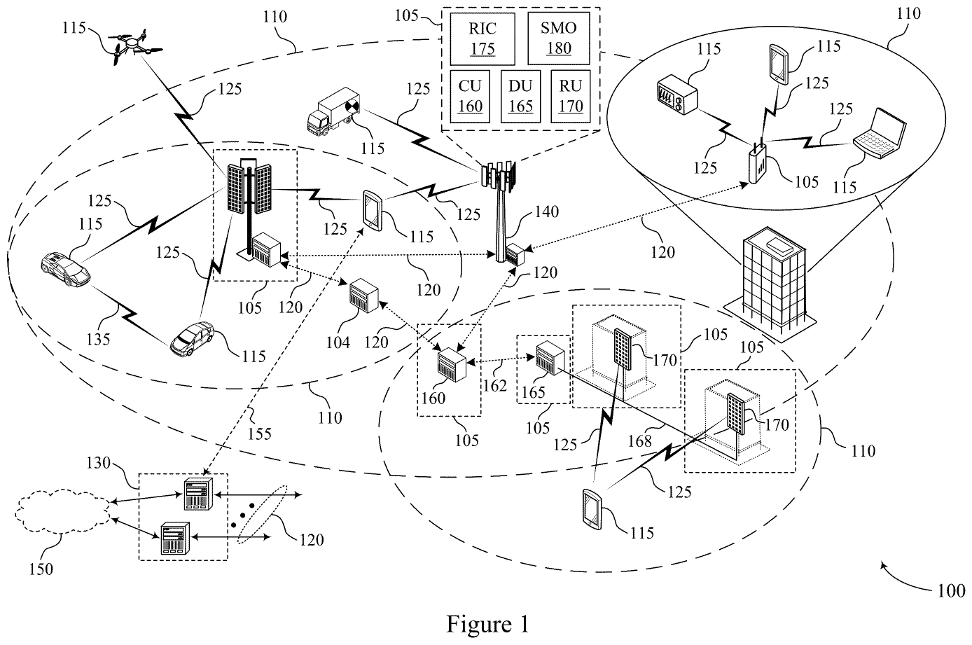

FIG. 1 shows an example of a wireless communications system 100 that supports techniques for random access in wireless communications in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support techniques for random access in wireless communications as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

Some UEs 115, such as MTC or IoT devices, may be relatively low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

In accordance with some aspects, a UE 115 may transmit a random access request to a network entity 105, such as a RACH message-1 (MSG1) of a CBRA procedure. The network entity 105 may receive the random access request and transmit a random access response. In some aspects, if the network entity 105 supports early identification of UE 115 features during CBRA (e.g., a reduced bandwidth capability of the UE 115, a coverage enhancement condition of the UE 115, or a payload size associated with a RACH message subsequent to the random access response), but does not configure a dedicated PRACH resource pool for the supported feature(s), the UE 115 may indicate the feature combination in the uplink RACH message (e.g., MSG3) if the uplink grant in the random access response provides sufficient resources. In some cases, if the uplink grant is not valid for early identification (e.g., provides insufficient uplink resources) the UE 115 may transmit a scheduling request to the network entity 105 and request a new uplink grant that is valid for indication of the early identification features of the UE 115. In further cases, additionally or alternatively, the UE 115 may indicate the feature combination in the uplink random access message (e.g., MSG3) after performing an uplink grant adaptation, if the uplink grant in the random access response is invalid and the UE 115 is capable of adapting the uplink grant (such as adaptation of a waveform associated with the uplink grant, puncturing one or more RBs or symbols associated with the uplink grant, or any combination thereof). In some aspects, one or more criteria or thresholds for uplink grant validation may be separately configured by the network entity 105, and the UE 115 may select a response based on such a configuration. In some aspects, the network entity 105 may configure a scheduling request indication, uplink grant adaptation, or both, in SI, RRC signaling, in the random access response, or any combination thereof. In some aspects, activation or deactivation of such techniques, and a scheduling request resource indication, may be dynamically signaled in the random access response.

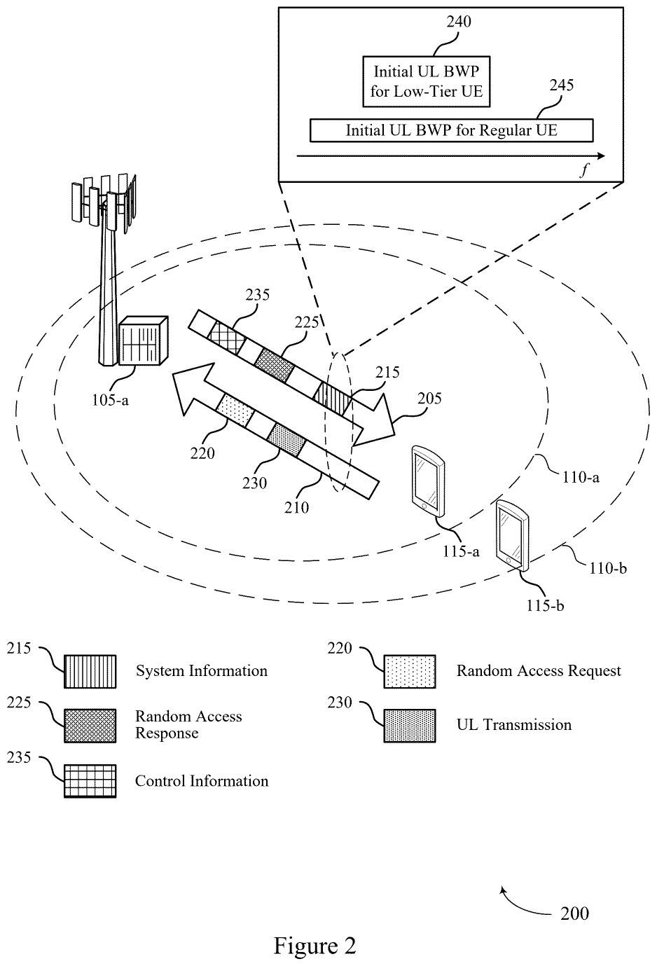

FIG. 2 shows an example of a wireless communications system 200 that supports techniques for random access in wireless communications. The wireless communications system 200 may implement aspects of or may be implemented by aspects of the wireless communications system 100. For example, the wireless communications system 200 includes a UE 115-a and a UE 115-b, which may be examples of a UE 115 as described herein. The wireless communications system 200 may also include a network entity 105-a, which may be an example of a network entity 105 as described herein.

The UEs 115 may communicate with the network entity 105-a using associated communication links, such as a downlink 205 portion of a communication link and an uplink 210 portion of the communications link, which may be examples of an NR or LTE link between the UEs 115 and the network entity 105-a. The communication link may include bi-directional links that enable both uplink and downlink communications. For example, the network entity 105-a may transmit downlink signals (e.g., downlink transmissions), such as downlink control signaling and downlink data signals, to the UE 115-a and the UE 115-b using the downlink 205 portion of communication link, and the UE 115-a may transmit uplink signals (e.g., uplink transmissions), such as uplink control signaling and uplink data signals, to the network entity 105-a using the uplink 210 portion of the communication link.

In wireless communications system 200, one both of the UE 115-a and the UE 115-b, and the network entity 105-a, may perform a random access procedure (e.g., a RACH procedure, a physical random access channel (PRACH) procedure). In some examples, to facilitate performing such procedures, the network entity 105-a may transmit system information 215 (e.g., system information block (SIB) signaling) that indicates a random access configuration to the UEs 115, according to which the UEs 115 may perform the random access procedure. The random access configuration may include or indicate one or more random access parameters, including one or more periodicity parameters, RACH occasion quantity parameters, random access slot parameters, random access configuration index parameters, or any combination thereof. The random access configuration may be identified by or otherwise associated with an index that may facilitate indication of the random access configuration. In the example of FIG. 2, the UE 115-a may be located relatively close to the network entity 105-a, in first coverage area 110-a, and the UE 115-b may be located relatively further away from the network entity 105-a in a second coverage area 110-b, which may be associated with one or more coverage enhancement (CE) techniques (e.g., additional repetitions of transmissions, frequency hopping for transmissions, or any combination thereof). Further, in this example, the UE 115-a may be a lower tier or reduced complexity UE 115, which may operate on a reduced initial bandwidth part 240 relative to a full initial bandwidth part 245 of a regular UE 115. As discussed herein, in some aspects a UE 115 may indicate one or more features that may indicate a cell edge condition such as for UE 115-b, a reduced complexity such as for UE 115-a, one or more other features (e.g., if a payload is to be provided in an uplink RACH message, such as MSG3), or any combination thereof.

As discussed herein, in accordance with some aspects a UE 115 may transmit a random access request 220 to network entity 105-a, such as a RACH MSG1 of a CBRA procedure. The network entity 105-a may receive the random access request and transmit a random access response 225. In some aspects, if the network entity 105-a supports early identification of UE 115 features during CBRA (e.g., a reduced bandwidth capability of the UE 115-a, a coverage enhancement condition of the UE 115-b, or a payload size associated with an uplink transmission 230 that includes a subsequent RACH message (e.g., MSG3) subsequent to the random access response), but does not configure a dedicated PRACH resource pool for the supported feature(s), the UEs 115 may indicate the feature combination in the uplink transmission 230 (e.g., MSG3) if the uplink grant in the random access response 225 provides sufficient resources. In some cases, if the uplink grant is not valid for early identification (e.g., provides insufficient uplink resources) the UEs 115 may transmit a scheduling request to the network entity 105 in the uplink transmission 230 and request a new uplink grant that is valid for indication of the early identification features of the UE 115. In further cases, additionally or alternatively, one or both UEs 115 may indicate the feature combination in the uplink transmission 230 (e.g., MSG3) after performing an uplink grant adaptation, if the uplink grant in the random access response 225 is invalid and the UE 115 is capable of adapting the uplink grant (such as adaptation of a waveform associated with the uplink grant, puncturing one or more RBs or symbols associated with the uplink grant, or any combination thereof). In some aspects, one or more criteria or thresholds for uplink grant validation may be separately configured by the network entity 105-a, and UEs 115 may select a response based on such a configuration. In some aspects, the network entity 105-a may configure a scheduling request indication, uplink grant adaptation, or both, in SI, RRC signaling, in the random access response 225, or any combination thereof. In some aspects, activation or deactivation of such techniques, and a scheduling request resource indication, may be dynamically signaled in the random access response 225. In some cases, control information 235 may be transmitted by the network entity 105-a subsequent to MSG3 (e.g., a MSG4 transmission that provides contention resolution).

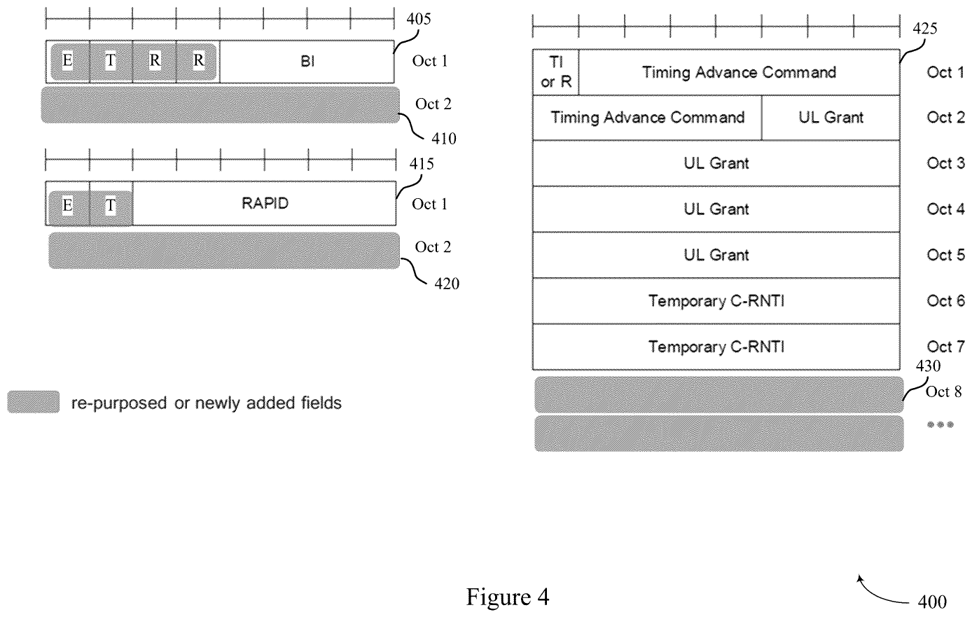

In some aspects, if a UE 115 receives an uplink grant for the uplink transmission 230 (e.g., MSG3) which is not valid for an early identification indication of UE 115 features, the UE 115 may can skip the associated RACH transmission (e.g., MSG3 transmission) and send a scheduling request in the uplink transmission 230 that requests a valid uplink grant. In some aspects, the scheduling request may re-use a PUCCH resource for a payload size of M-bits (e.g., M≥1, to include an indication for the valid uplink grant type, such as indicated in TABLE 1; or a compact UE ID that is associated with a particular grant type), or be configured with a different waveform associated with the corresponding UE 115 feature. For example, if early identification is intended for uplink coverage enhancement of a regular UE 115-b, a PUCCH resource set with intra/inter-slot frequency hopping may be configured on the two edges of the associated uplink carrier. In other examples, if the early identification is intended for a low-tier UE 115-a with a reduced bandwidth capability, a low-peak-to-average-power (low-PAPR) waveform different from a PUCCH waveform may be transmitted within the narrowband initial uplink bandwidth part. In some aspects, to maintain uplink synchronization, a UE 115 will apply a timing advance command (TAC) indicated in the random access response 225 to the scheduling request transmission. In some aspects, if a MAC protocol data unit (PDU) mapped to the random access response 225 carries multiple random access preamble IDs (RAPIDs), a UE 115 will parse the random access response 225 with a matched RAPID MAC subheader. FIG. 4 illustrates some examples MAC control messages that may provide an indication of scheduling request resources. As discussed, the random access response 225 may include an indication for the valid uplink grant type, such as provided in a two-bit payload and mapped to a grant type in accordance with the example in TABLE 1:

TABLE 1
Scheduling Request Payload and Waveform Mapping
For UL Grant Type

| Index of | | Payload | Configuration |
|---|---|---|---|
| Valid UL | | for | for Scheduling |
| Grant | | PUCCH- | Request |
| Type | Type of Valid UL Grant | based SR | Waveform |
| 0 | Coverage Enhancement For | 00 | A |
| | MSG3 of Regular UE | | |
| 1 | Coverage Enhancement | 01 | B |
| | For Small Data Transmission | | |
| | (SDT) of low-tier UE | | |
| 2 | Network Slicing for Regular UE | 10 | C |
| 3 | Low-tier UE with | 11 | D |
| | reduced Bandwidth | | |

In some aspects, to support a scheduling request transmission in the uplink transmission 230, the functionalities of the random access request 220 PDCCH and/or PDSCH may be configured to indicate information related to the scheduling request. For example, the random access request 220 PDCCH and/or PDSCH may provide an activation or deactivation of a scheduling request that may be provided in the uplink transmission 230. In one example, the activation or deactivation of a scheduling request may be indicated in a downlink control information (DCI) of a PDCCH of the random access response 225 (e.g., DCI field of MSG2 PDCCH). In another example, the indication may be provided in a MAC sub-header for a backoff indicator, or a MAC sub-header for a RAPID indicator, in an information field of the random access response 225, or any combination thereof. In some aspects, a timing offset and resource indication for the scheduling request SR may be provided in the random access response 225 by a joint indication in an associated PDCCH (e.g., derived from control channel element (CCE) mapping, or extracted from a DCI codepoint) and PDSCH (e.g., extracted from MAC sub-headers and/or random access response field), or by an indication included only in PDSCH (e.g., MAC sub-headers and random access response field). In some aspects, to accommodate a UE 115 timeline for transmission of a scheduling request, the network entity 105-a may provide that a timing offset between a last symbol of a PDSCH of the random access response 225 and a first symbol of the uplink transmission 230 is no less than the minimum gap associated with a timing advance and scheduling request waveform preparation. In some aspects, a timer may be configured for the enhanced scheduling request, which may specify a time window for a UE 115 to monitor for the on-demand uplink grant for early identification that may be provided in control information 235.

In some aspects, additionally or alternatively, the network entity 105-a may, based on available uplink resources, provide an uplink grant for (1) the uplink transmission 230, (2) a scheduling request, or (3) an ordered PRACH resource, to accommodate early indication of multiple UE types. For example, if the network entity 105-a supports initial access of three UE types, the scheduling information carried by the random access response 225 (e.g., in associated PDCCH/PDSCH) can include one of: an uplink grant valid for a first type of UE plus an uplink grant valid for a second type of UE; an uplink grant valid for the first type of UE plus a scheduling request valid for the second type of UE; an uplink grant valid for the first type of UE plus a PDCCH/PDSCH ordered PRACH resource for the second type of UE; a scheduling request valid for the first type of UE plus a scheduling request valid for the second type of UE; or a scheduling request valid for the first type of UE plus a PDCCH/PDSCH ordered PRACH resource for the second type of UE.

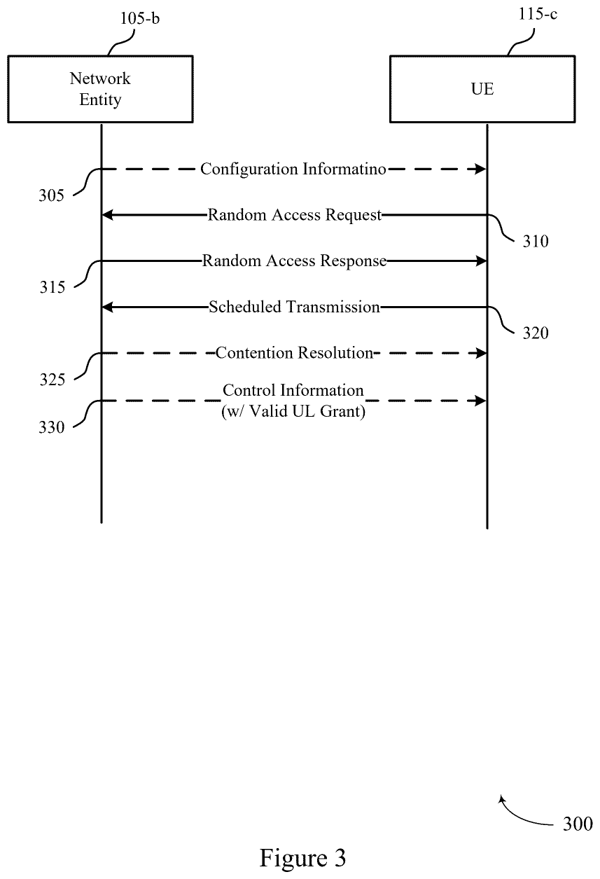

FIG. 3 shows an example of a process flow 300 that supports techniques for random access in wireless communications. In some examples, the process flow 300 may implement or be implemented by aspects of the wireless communications systems 100 and 200 as described with reference to FIGS. 1 and 2, respectively. For example, the process flow 300 may be implemented by a network entity 105-b, which may be an example of the network entities 105 as described with reference to FIGS. 1 and 2. The process flow 300 may be implemented by a UE 115-c, which may be an example of the UEs as described with reference to FIGS. 1 and 2.

In some examples, the operations illustrated in process flow 300 may be performed by hardware (e.g., including circuitry, processing blocks, logic components, and other components), code (e.g., software executed by a processor), or any combination thereof. Alternative examples of the following may be implemented, where some steps are performed in a different order than described or are not performed at all. In some cases, steps may include additional features not mentioned below, or further steps may be added.

At 305, optionally, the network entity 105-b may transmit, and the UE 115-c may receive, configuration information that configures a RACH procedure in accordance with aspects discussed herein. In some aspects, the configuration information may be provided in one or more SI transmissions (e.g., one or more SIBs) of the network entity 105-b. In some cases, the configuration information may indicate that a random access response may provide scheduling request indication, or that an uplink grant provided in a random access response may be adapted in accordance with an uplink transmission capability of the UE 115-c (e.g., a bandwidth capability of the UE 115-c).

At 310, the UE 115-c may transmit, and the network entity 105-b may receive, a random access request. In some aspects, the random access request may be a MSG1 transmission of CBRA procedure, as discussed herein. At 315, the network entity 105-b may transmit, and the UE 115-c may receive, a random access response. The random access response may include, as discussed herein, an uplink grant for a subsequent uplink transmission, which may include a scheduled transmission (e.g., a MSG3 transmission) or a scheduling request transmission. In some aspects, as discussed herein, the UE may transmit the scheduling request if the uplink grant of the random access response is invalid for an uplink transmission of the UE 115-c and the UE 115-c is not able to adapt the uplink grant to provide the uplink transmission. At 320, the UE 115-c may transmit, and the network entity 105-b may receive, the scheduled transmission. As discussed herein, the scheduled transmission may include a subsequent uplink transmission of the CBRA procedure (e.g., a MSG3 transmission), or a scheduling request transmission that requests a valid uplink grant for the UE 115-c.

Optionally, at 325, the network entity 105-b may transmit, and the UE 115-c may receive, a contention resolution message. In some cases, the contention resolution message may be a MSG4 transmission of a CBRA procedure. Optionally, at 330, the network entity 105-b may transmit, and the UE 115-c may receive, control information that may indicate a valid uplink grant for the UE 115-c.

FIG. 4 shows examples of MAC messages 400 that support techniques for random access in wireless communications. The MAC messages 400 may implement aspects of or may be implemented by aspects of the wireless communications system 100 and wireless communications system 200. In some aspects, one or more MAC control messages 400 may include new or repurposed fields that provide an indication of scheduling request resources. For example, a backoff indicator (BI) MAC subheader 405 may include one or more fields (e.g., one or more extension (E), type (T), or reserved (R) fields) that may be used to indicate scheduling request information, or a separate field 410 may be provided for such a MAC subheader 405. In another example, a RAPID MAC subheader 415 may provide an indication of scheduling request resources (e.g., in one or more E or T fields), or a separate field 420 may be provided for such a MAC subheader 415. In further examples, MAC signaling associated with a timing advance command 425 may include one or more additional octets 430 that indicate scheduling request information.

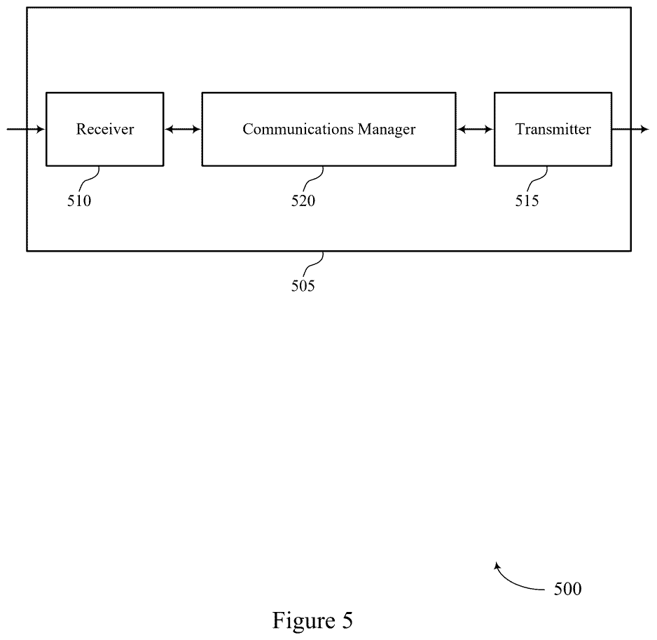

FIG. 5 shows a block diagram 500 of a device 505 that supports techniques for random access in wireless communications in accordance with one or more aspects of the present disclosure. The device 505 may be an example of aspects of a UE 115 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to, individually or collectively, support or enable the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to techniques for random access in wireless communications). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to techniques for random access in wireless communications). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations or components thereof may be examples of means for performing various aspects of techniques for random access in wireless communications as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software or firmware) executed by at least one processor (e.g., referred to as a processor-executable code). If implemented in code executed by at least one processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. For example, the communications manager 520 is capable of, configured to, or operable to support a means for transmitting a random access request to a network entity. The communications manager 520 is capable of, configured to, or operable to support a means for receiving a random access response that provides an indication of an uplink grant for an uplink message subsequent to the random access request, the uplink grant including at least a first uplink resource for a random access message and a second uplink resource for a scheduling request. The communications manager 520 is capable of, configured to, or operable to support a means for selecting an uplink transmission resource for the uplink message from the first uplink resource or the second uplink resource, the uplink message including the random access message or the scheduling request in accordance with the selected uplink transmission resource. The communications manager 520 is capable of, configured to, or operable to support a means for transmitting the uplink message via the selected uplink transmission resource.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for indication of one or more UE features in a random access procedure, with reduced overhead associated with PRACH resources, that provides for reduced power consumption and enhanced reliability, quality, and latency.

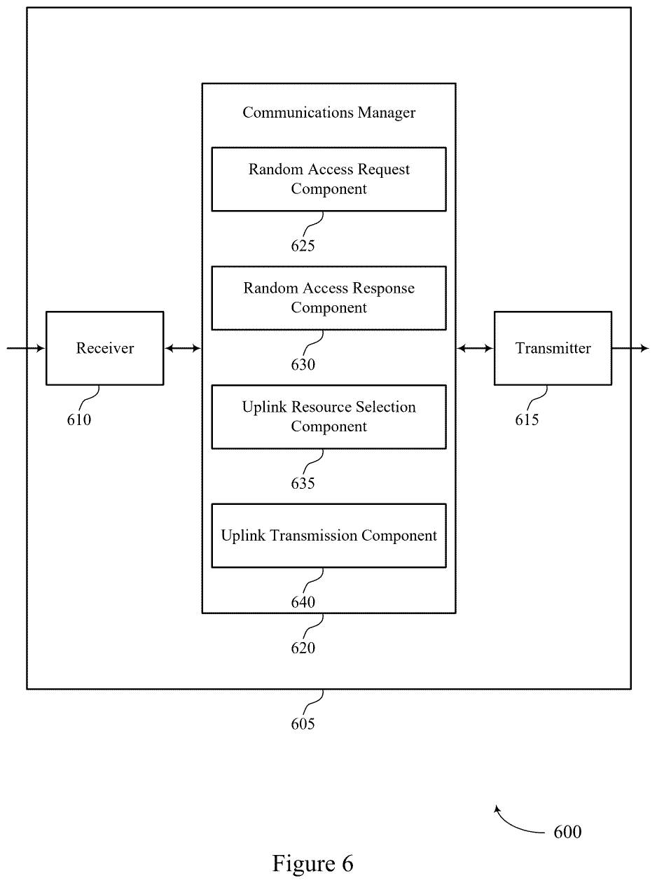

FIG. 6 shows a block diagram 600 of a device 605 that supports techniques for random access in wireless communications. The device 605 may be an example of aspects of a device 505 or a UE 115 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to support the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to techniques for random access in wireless communications). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to techniques for random access in wireless communications). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of techniques for random access in wireless communications as described herein. For example, the communications manager 620 may include a random access request component 625, a random access response component 630, an uplink resource selection component 635, an uplink transmission component 640, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. The random access request component 625 is capable of, configured to, or operable to support a means for transmitting a random access request to a network entity. The random access response component 630 is capable of, configured to, or operable to support a means for receiving a random access response that provides an indication of an uplink grant for an uplink message subsequent to the random access request, the uplink grant including at least a first uplink resource for a random access message and a second uplink resource for a scheduling request. The uplink resource selection component 635 is capable of, configured to, or operable to support a means for selecting an uplink transmission resource for the uplink message from the first uplink resource or the second uplink resource, the uplink message including the random access message or the scheduling request in accordance with the selected uplink transmission resource. The uplink transmission component 640 is capable of, configured to, or operable to support a means for transmitting the uplink message via the selected uplink transmission resource.

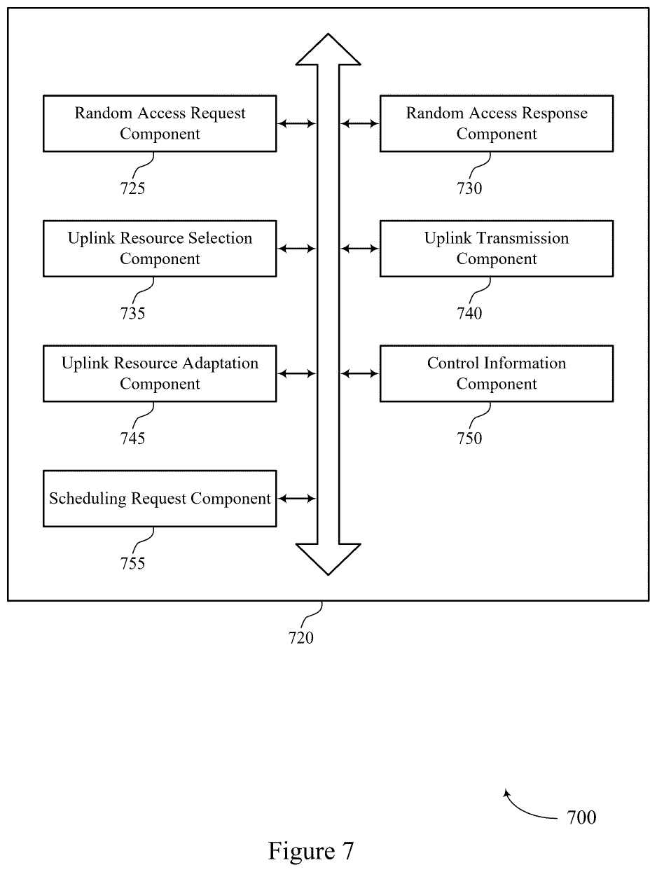

FIG. 7 shows a block diagram 700 of a communications manager 720 that supports techniques for random access in wireless communications in accordance with one or more aspects of the present disclosure. The communications manager 720 may be an example of aspects of a communications manager 520, a communications manager 620, or both, as described herein. The communications manager 720, or various components thereof, may be an example of means for performing (e.g., to cause the communications manager 720 to perform) various aspects of techniques for random access in wireless communications as described herein. For example, the communications manager 720 may include a random access request component 725, a random access response component 730, an uplink resource selection component 735, an uplink transmission component 740, an uplink resource adaptation component 745, a control information component 750, a scheduling request component 755, or any combination thereof. Each of these components, or components or subcomponents thereof (e.g., one or more processors, one or more memories), may communicate, directly or indirectly, with one another (e.g., via one or more buses).

The communications manager 720 may support wireless communications in accordance with examples as disclosed herein. The random access request component 725 is capable of, configured to, or operable to support a means for transmitting a random access request to a network entity. The random access response component 730 is capable of, configured to, or operable to support a means for receiving a random access response that provides an indication of an uplink grant for an uplink message subsequent to the random access request, the uplink grant including at least a first uplink resource for a random access message and a second uplink resource for a scheduling request. The uplink resource selection component 735 is capable of, configured to, or operable to support a means for selecting an uplink transmission resource for the uplink message from the first uplink resource or the second uplink resource, the uplink message including the random access message or the scheduling request in accordance with the selected uplink transmission resource. The uplink transmission component 740 is capable of, configured to, or operable to support a means for transmitting the uplink message via the selected uplink transmission resource.

In some examples, the selected uplink transmission resource is for the random access message when the first uplink resource for the random access message provides sufficient uplink resources to indicate one or more features that are supported by the UE.

In some examples, the uplink resource selection component 735 is capable of, configured to, or operable to support a means for determining the first uplink resource for the random access message is invalid for transmission of the random access message. In some examples, the uplink resource selection component 735 is capable of, configured to, or operable to support a means for transmitting the scheduling request via the second uplink resource for the scheduling request, where the scheduling request indicates a request for a valid uplink grant for transmission of the random access message.

In some examples, to support transmitting the uplink message, the uplink resource adaptation component 745 is capable of, configured to, or operable to support a means for adapting the first uplink resource for the random access message to provide an indication of one or more features that are supported by the UE. In some examples, to support transmitting the uplink message, the uplink transmission component 740 is capable of, configured to, or operable to support a means for transmitting the uplink message via the adapted first uplink resource.

In some examples, the uplink resource adaptation component 745 is capable of, configured to, or operable to support a means for adapting a waveform for the random access message to be transmitted via the first uplink resource. In some examples, the uplink resource adaptation component 745 is capable of, configured to, or operable to support a means for puncturing one or more resource blocks of the first uplink resource. In some examples, the uplink resource adaptation component 745 is capable of, configured to, or operable to support a means for puncturing one or more symbols of the first uplink resource.

In some examples, the control information component 750 is capable of, configured to, or operable to support a means for receiving control information that indicates the second uplink resource for the scheduling request is provided in the random access response, the first uplink resource is modifiable to provide an indication of one or more features that are supported by the UE, or any combination thereof. In some examples, the control information is provided in one or more of system information, radio resource control signaling, or the random access response.

In some examples, the control information indicates one or more of a resource configuration for a scheduling request message associated with the second uplink resource, or one or more thresholds associated with selection of the first uplink resource or the second uplink resource for the uplink message. In some examples, the control information indicates one or more adaptations available for the first uplink resource for transmission of the random access message, or one or more thresholds associated with selection of the first uplink resource or the second uplink resource for the uplink message, or any combination thereof.

In some examples, the uplink message includes the scheduling request and the uplink grant indicates control channel resources, and where the scheduling request includes a payload that indicates a type of grant that is requested by the UE or an identification associated with the UE. In some examples, the uplink message includes the scheduling request that is transmitted using a waveform selected from a set of available waveforms that indicates one or more features associated with a type of grant that is requested by the UE. In some examples, the random access response further indicates a timing advance value that is applied for transmission of the uplink message.

In some examples, the random access response further indicates the second uplink resource is active in accordance with one of a control information field of a control channel associated with the random access response, a medium access control (MAC) header field associated with a backoff indication, a MAC header field associated with a random access preamble identifier of the random access request, or an information field within the random access response. In some examples, the random access response further indicates a timing offset associated with the second uplink resource, and where the timing offset is provided in a joint indication of a control channel and a shared channel associated with the random access response, or the timing offset is provided only in the shared channel associated with the random access response.

In some examples, the timing offset is between a last symbol of a shared channel associated with the random access response and an initial symbol of the second uplink resource, and corresponds to a time gap associated with a timing advance and a waveform preparation time associated with transmission of the scheduling request.

In some examples, the uplink transmission component 740 is capable of, configured to, or operable to support a means for initiating a timer responsive to transmission of the scheduling request via the second uplink resource, the timer providing a time window for monitoring for a subsequent uplink grant associated with the scheduling request. In some examples, the indication of the uplink grant in the random access response indicates an ordered random access channel resource for early indication of multiple UE types.

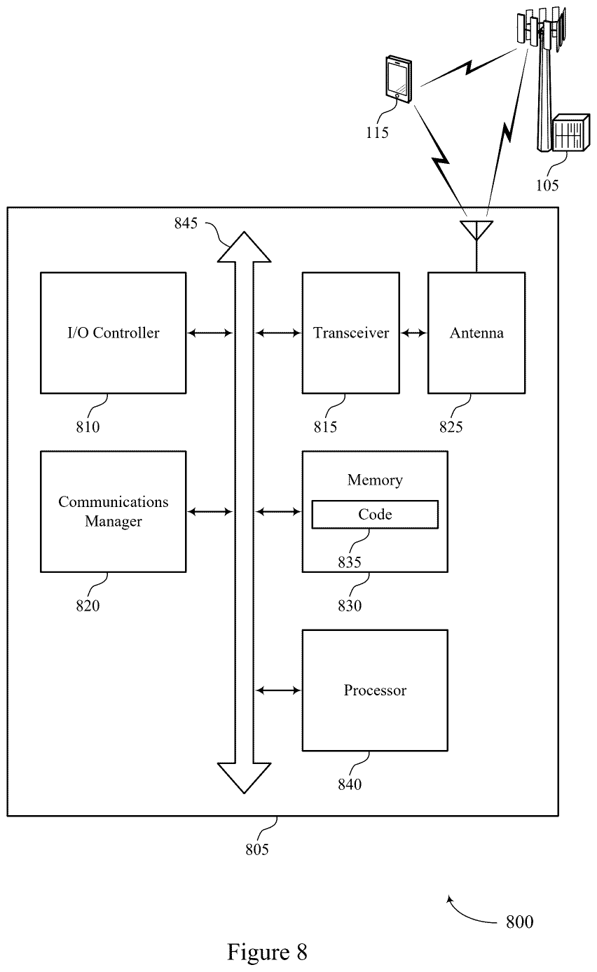

FIG. 8 shows an example of a system 800 including a device 805 that supports techniques for random access in wireless communications. The device 805 may be an example of or include components of a device 505, a device 605, or a UE 115 as described herein. The device 805 may communicate (e.g., wirelessly) with one or more other devices (e.g., network entities 105, UEs 115, or a combination thereof). The device 805 may include a communications manager 820, an input/output (I/O) controller, such as an I/O controller 810, a transceiver 815, one or more antennas 825, at least one memory 830, code 835, and at least one processor 840. Components of the device 805 may be coupled (such as operatively, communicatively, functionally, electronically, electrically, in electronic communication) a bus 845.

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of one or more processors, such as the at least one processor 840. In some cases, a user may interact with the device 805 via the I/O controller 810 or via hardware components controlled by the I/O controller 810.

In some cases, the device 805 may include a single antenna. However, in some other cases, the device 805 may have more than one antenna, which may be capable of concurrently transmitting or receiving multiple wireless transmissions. The transceiver 815 may communicate bi-directionally via the one or more antennas 825 using wired or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The at least one memory 830 may include random access memory (RAM) and read-only memory (ROM). The at least one memory 830 may store computer-readable, computer-executable, or processor-executable code, such as the code 835. The code 835 may include instructions that, when executed by the at least one processor 840, cause the device 805 to perform various functions described herein. The code 835 may be stored in a non-transitory computer-readable medium such as system memory or another type of memory. In some cases, the code 835 may not be directly executable by the at least one processor 840 but may cause a computer (e.g., when compiled and executed) to perform functions described herein. In some cases, the at least one memory 830 may include, among other things, a basic I/O system (BIOS) which may control basic hardware or software operation such as the interaction with peripheral components or devices.

The at least one processor 840 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 840 may be configured to operate a memory array using a memory controller. In some other cases, a memory controller may be integrated into the at least one processor 840. The at least one processor 840 may be configured to execute computer-readable instructions stored in a memory (e.g., the at least one memory 830) to cause the device 805 to perform various functions (e.g., functions or tasks supporting techniques for random access in wireless communications). For example, the device 805 or a component of the device 805 may include at least one processor 840 and at least one memory 830 coupled with or to the at least one processor 840, the at least one processor 840 and the at least one memory 830 configured to perform various functions described herein.

In some examples, the at least one processor 840 may include multiple processors and the at least one memory 830 may include multiple memories. One or more of the multiple processors may be coupled with one or more of the multiple memories, which may, individually or collectively, be configured to perform various functions described herein. In some examples, the at least one processor 840 may be a component of a processing system, which may refer to a system (such as a series) of machines, circuitry (including, for example, one or both of processor circuitry (which may include the at least one processor 840) and memory circuitry (which may include the at least one memory 830)), or components, that receives or obtains inputs and processes the inputs to produce, generate, or obtain a set of outputs. The processing system may be configured to perform one or more of the functions described herein. For example, the at least one processor 840 or a processing system including the at least one processor 840 may be configured to, configurable to, or operable to cause the device 805 to perform one or more of the functions described herein. Further, as described herein, being “configured to,” being “configurable to,” and being “operable to” may be used interchangeably and may be associated with a capability, when executing code 835 (e.g., processor-executable code) stored in the at least one memory 830 or otherwise, to perform one or more of the functions described herein.

The communications manager 820 may support wireless communications in accordance with examples as disclosed herein. For example, the communications manager 820 is capable of, configured to, or operable to support a means for transmitting a random access request to a network entity. The communications manager 820 is capable of, configured to, or operable to support a means for receiving a random access response that provides an indication of an uplink grant for an uplink message subsequent to the random access request, the uplink grant including at least a first uplink resource for a random access message and a second uplink resource for a scheduling request. The communications manager 820 is capable of, configured to, or operable to support a means for selecting an uplink transmission resource for the uplink message from the first uplink resource or the second uplink resource, the uplink message including the random access message or the scheduling request in accordance with the selected uplink transmission resource. The communications manager 820 is capable of, configured to, or operable to support a means for transmitting the uplink message via the selected uplink transmission resource.

By including or configuring the communications manager 820 for operation in the device 805 as described herein, may support techniques for indication of one or more UE features in a random access procedure, with reduced overhead associated with PRACH resources, that provides for reduced power consumption and enhanced reliability, quality, and latency.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the at least one processor 840, the at least one memory 830, the code 835, or any combination thereof. For example, the code 835 may include instructions executable by the at least one processor 840 to cause the device 805 to perform various aspects of techniques for random access in wireless communications as described herein, or the at least one processor 840 and the at least one memory 830 may be otherwise configured to, individually or collectively, perform or support such operations.

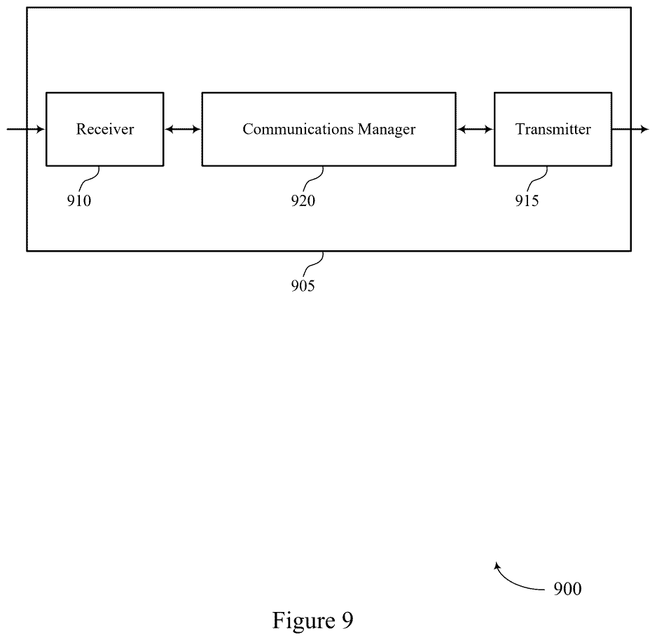

FIG. 9 shows a block diagram 900 of a device 905 that supports techniques for random access in wireless communications in accordance with one or more aspects of the present disclosure. The device 905 may be an example of aspects of a network entity 105 as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to, individually or collectively, support or enable the described techniques. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The communications manager 920, the receiver 910, the transmitter 915, or various combinations or components thereof may be examples of means for performing various aspects of techniques for random access in wireless communications as described herein. For example, the communications manager 920, the receiver 910, the transmitter 915, or various combinations or components thereof may be capable of performing one or more of the functions described herein.

In some examples, the communications manager 920, the receiver 910, the transmitter 915, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 920, the receiver 910, the transmitter 915, or various combinations or components thereof may be implemented in code (e.g., as communications management software or firmware) executed by at least one processor (e.g., referred to as a processor-executable code). If implemented in code executed by at least one processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. For example, the communications manager 920 is capable of, configured to, or operable to support a means for receiving a random access request from a UE. The communications manager 920 is capable of, configured to, or operable to support a means for transmitting, to the UE, a random access response that provides an indication of an uplink grant for an uplink message subsequent to the random access request, the uplink grant including at least a first uplink resource for a random access message and a second uplink resource for a scheduling request. The communications manager 920 is capable of, configured to, or operable to support a means for monitoring the first uplink resource for the random access message and the second uplink resource for the scheduling request.

By including or configuring the communications manager 920 in accordance with examples as described herein, the device 905 (e.g., at least one processor controlling or otherwise coupled with the receiver 910, the transmitter 915, the communications manager 920, or a combination thereof) may support techniques for indication of one or more UE features in a random access procedure, with reduced overhead associated with PRACH resources, that provides for reduced power consumption and enhanced reliability, quality, and latency.

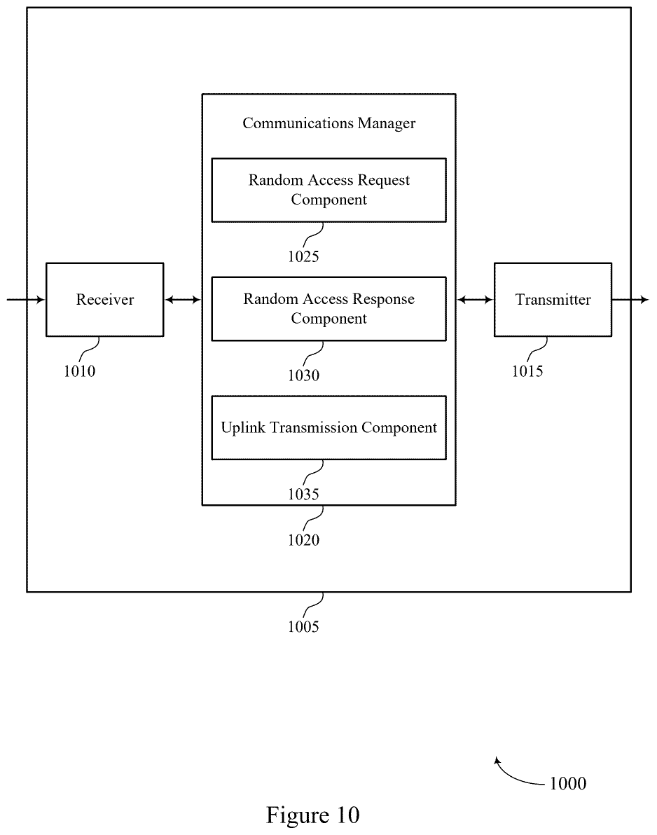

FIG. 10 shows a block diagram 1000 of a device 1005 that supports techniques for random access in wireless communications. The device 1005 may be an example of aspects of a device 905 or a network entity 105 as described herein. The device 1005 may include a receiver 1010, a transmitter 1015, and a communications manager 1020. The device 1005, or one or more components of the device 1005 (e.g., the receiver 1010, the transmitter 1015, the communications manager 1020), may include at least one processor, which may be coupled with at least one memory, to support the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The device 1005, or various components thereof, may be an example of means for performing various aspects of techniques for random access in wireless communications as described herein. For example, the communications manager 1020 may include a random access request component 1025, a random access response component 1030, an uplink transmission component 1035, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications in accordance with examples as disclosed herein. The random access request component 1025 is capable of, configured to, or operable to support a means for receiving a random access request from a UE. The random access response component 1030 is capable of, configured to, or operable to support a means for transmitting, to the UE, a random access response that provides an indication of an uplink grant for an uplink message subsequent to the random access request, the uplink grant including at least a first uplink resource for a random access message and a second uplink resource for a scheduling request. The uplink transmission component 1035 is capable of, configured to, or operable to support a means for monitoring the first uplink resource for the random access message and the second uplink resource for the scheduling request.

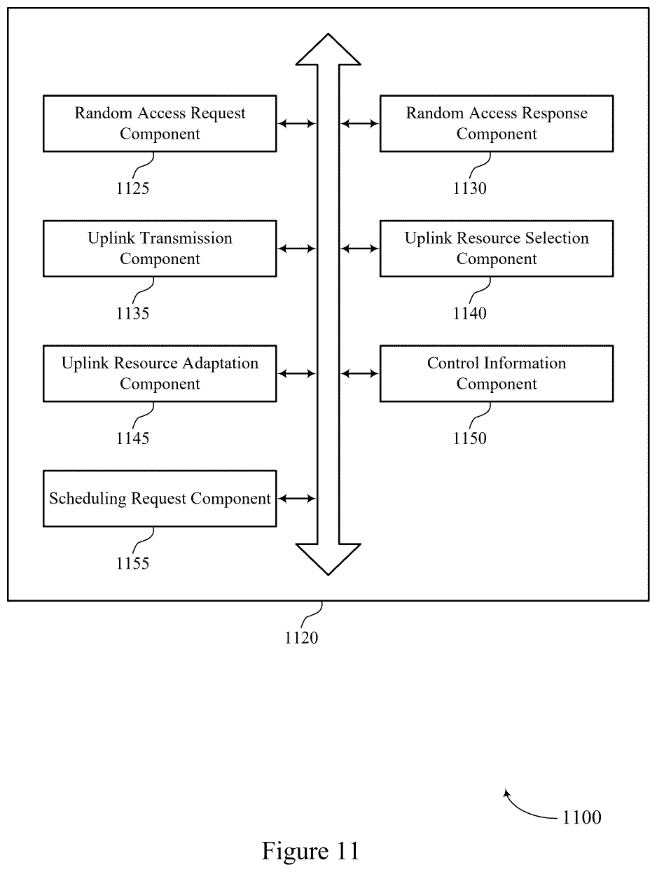

FIG. 11 shows a block diagram 1100 of a communications manager 1120 that supports techniques for random access in wireless communications in accordance with one or more aspects of the present disclosure. The communications manager 1120 may be an example of aspects of a communications manager 920, a communications manager 1020, or both, as described herein. The communications manager 1120, or various components thereof, may be an example of means for performing (e.g., to cause the communications manager 1120 to perform) various aspects of techniques for random access in wireless communications as described herein. For example, the communications manager 1120 may include a random access request component 1125, a random access response component 1130, an uplink transmission component 1135, an uplink resource selection component 1140, an uplink resource adaptation component 1145, a control information component 1150, a scheduling request component 1155, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1120 may support wireless communications in accordance with examples as disclosed herein. The random access request component 1125 is capable of, configured to, or operable to support a means for receiving a random access request from a UE. The random access response component 1130 is capable of, configured to, or operable to support a means for transmitting, to the UE, a random access response that provides an indication of an uplink grant for an uplink message subsequent to the random access request, the uplink grant including at least a first uplink resource for a random access message and a second uplink resource for a scheduling request. The uplink transmission component 1135 is capable of, configured to, or operable to support a means for monitoring the first uplink resource for the random access message and the second uplink resource for the scheduling request.

In some examples, the uplink message is received via the first uplink resource when the first uplink resource provides sufficient uplink resources for the UE to indicate one or more features that are supported by the UE.

In some examples, the uplink resource selection component 1140 is capable of, configured to, or operable to support a means for receiving the scheduling request via the second uplink resource, the scheduling request indicating a request for a subsequent uplink grant with sufficient resources for the UE to indicate one or more features that are supported by the UE.

In some examples, the uplink resource adaptation component 1145 is capable of, configured to, or operable to support a means for receiving the random access message via the first uplink resource, where the first uplink resource is adapted to provide an indication of one or more features that are supported by the UE.

In some examples, an adapted waveform for the random access message transmitted via the first uplink resource. In some examples, one or more punctured resource blocks of the first uplink resource. In some examples, one or more punctured symbols of the first uplink resource.

In some examples, the control information component 1150 is capable of, configured to, or operable to support a means for transmitting control information that indicates the second uplink resource is provided in the random access response, the first uplink resource is modifiable to provide an indication of one or more features that are supported by the UE, or any combination thereof. In some examples, the control information is provided in one or more of system information, radio resource control signaling, or the random access response. In some examples, the control information indicates one or more of a resource configuration for the scheduling request associated with the second uplink resource, or one or more thresholds associated with selection of the first uplink resource or the second uplink resource for the uplink message.

In some examples, the control information indicates one or more adaptations available for the second uplink resource for transmission of the random access message, or one or more thresholds associated with selection of the first uplink resource or the second uplink resource for the uplink message, or any combination thereof. In some examples, the uplink message includes the scheduling request and the uplink grant indicates control channel resources, and where the scheduling request includes a payload that indicates a type of grant that is requested by the UE or an identification associated with the UE. In some examples, the uplink message includes the scheduling request that is transmitted using a waveform selected from a set of available waveforms that indicates one or more features associated with a type of grant that is requested by the UE. In some examples, the random access response further indicates a timing advance value that is to be applied for transmission of the uplink message.

In some examples, the random access response further indicates the second uplink resource is active in accordance with one of a control information field of a control channel associated with the random access response, a medium access control (MAC) header field associated with a backoff indication, a MAC header field associated with a random access preamble identifier of the random access request, or an information field within the random access response. In some examples, the random access response further indicates a timing offset associated with the second uplink resource, and where the timing offset is provided in a joint indication of a control channel and a shared channel associated with the random access response, or the timing offset is provided only in the shared channel associated with the random access response.

In some examples, the timing offset is between a last symbol of a shared channel associated with the random access response and an initial symbol of the second uplink resource, and corresponds to a time gap associated with a timing advance and a waveform preparation time associated with transmission of the scheduling request. In some examples, the indication of the uplink grant in the random access response indicates an ordered random access channel resource for early indication of multiple UE types.

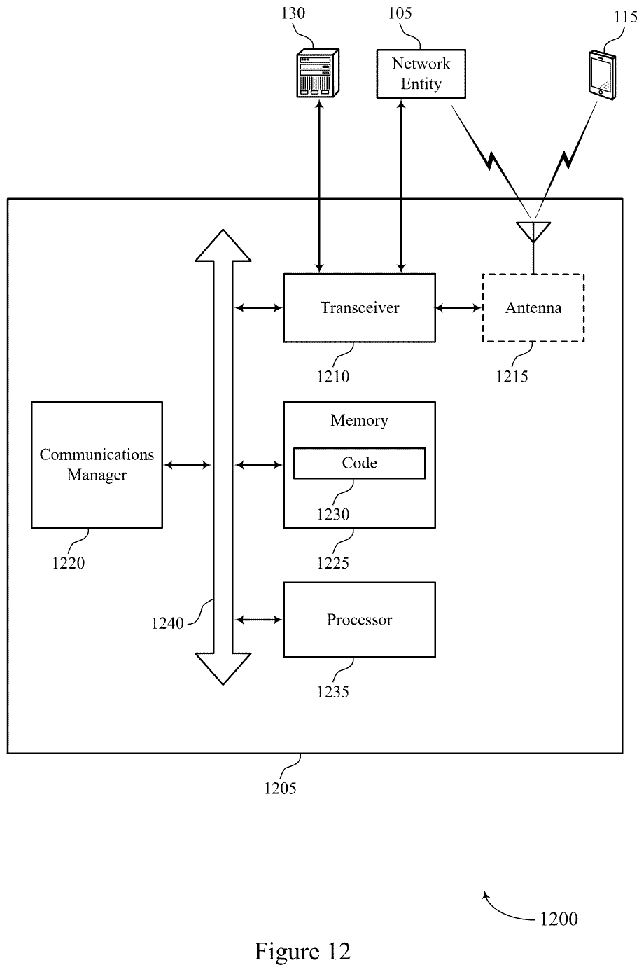

FIG. 12 shows an example of a system 1200 including a device 1205 that supports techniques for random access in wireless communications. The device 1205 may be an example of or include components of a device 905, a device 1005, or a network entity 105 as described herein. The device 1205 may communicate with other network devices or network equipment such as one or more of the network entities 105, UEs 115, or any combination thereof. The communications may include communications over one or more wired interfaces, over one or more wireless interfaces, or any combination thereof. The device 1205 may include components that support outputting and obtaining communications, such as a communications manager 1220, a transceiver 1210, one or more antennas 1215, at least one memory 1225, code 1230, and at least one processor 1235. Components of the device 1205 may be coupled (such as operatively, communicatively, functionally, electronically, electrically, in electronic communication) a bus 1240.

The transceiver 1210 may support bi-directional communications via wired links, wireless links, or both as described herein. In some examples, the transceiver 1210 may include a wired transceiver and may communicate bi-directionally with another wired transceiver. Additionally, or alternatively, in some examples, the transceiver 1210 may include a wireless transceiver and may communicate bi-directionally with another wireless transceiver. In some examples, the device 1205 may include one or more antennas 1215, which may be capable of transmitting or receiving wireless transmissions (e.g., concurrently). The transceiver 1210 may also include a modem to modulate signals, to provide the modulated signals for transmission (e.g., by one or more antennas 1215, by a wired transmitter), to receive modulated signals (e.g., from one or more antennas 1215, from a wired receiver), and to demodulate signals. In some implementations, the transceiver 1210 may include one or more interfaces, such as one or more interfaces coupled with the one or more antennas 1215 that are configured to support various receiving or obtaining operations, or one or more interfaces coupled with the one or more antennas 1215 that are configured to support various transmitting or outputting operations, or a combination thereof. In some implementations, the transceiver 1210 may include or be configured for coupling with one or more processors or one or more memory components that are operable to perform or support operations based on received or obtained information or signals, or to generate information or other signals for transmission or other outputting, or any combination thereof. In some implementations, the transceiver 1210, or the transceiver 1210 and the one or more antennas 1215, or the transceiver 1210 and the one or more antennas 1215 and one or more processors or one or more memory components (e.g., the at least one processor 1235, the at least one memory 1225, or both), may be included in a chip or chip assembly that is installed in the device 1205. In some examples, the transceiver 1210 may be operable to support communications via one or more communications links (e.g., communication link(s) 125, backhaul communication link(s) 120, a midhaul communication link 162, a fronthaul communication link 168).

The at least one memory 1225 may include RAM, ROM, or any combination thereof. The at least one memory 1225 may store computer-readable, computer-executable, or processor-executable code, such as the code 1230. The code 1230 may include instructions that, when executed by one or more of the at least one processor 1235, cause the device 1205 to perform various functions described herein. The code 1230 may be stored in a non-transitory computer-readable medium such as system memory or another type of memory. In some cases, the code 1230 may not be directly executable by a processor of the at least one processor 1235 but may cause a computer (e.g., when compiled and executed) to perform functions described herein. In some cases, the at least one memory 1225 may include, among other things, a BIOS which may control basic hardware or software operation such as the interaction with peripheral components or devices. In some examples, the at least one processor 1235 may include multiple processors and the at least one memory 1225 may include multiple memories. One or more of the multiple processors may be coupled with one or more of the multiple memories which may, individually or collectively, be configured to perform various functions herein (for example, as part of a processing system).

The at least one processor 1235 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1235 may be configured to operate a memory array using a memory controller. In some other cases, a memory controller may be integrated into one or more of the at least one processor 1235. The at least one processor 1235 may be configured to execute computer-readable instructions stored in a memory (e.g., one or more of the at least one memory 1225) to cause the device 1205 to perform various functions (e.g., functions or tasks supporting techniques for random access in wireless communications). For example, the device 1205 or a component of the device 1205 may include at least one processor 1235 and at least one memory 1225 coupled with one or more of the at least one processor 1235, the at least one processor 1235 and the at least one memory 1225 configured to perform various functions described herein. The at least one processor 1235 may be an example of a cloud-computing platform (e.g., one or more physical nodes and supporting software such as operating systems, virtual machines, or container instances) that may host the functions (e.g., by executing code 1230) to perform the functions of the device 1205. The at least one processor 1235 may be any one or more suitable processors capable of executing scripts or instructions of one or more software programs stored in the device 1205 (such as within one or more of the at least one memory 1225).

In some examples, the at least one processor 1235 may include multiple processors and the at least one memory 1225 may include multiple memories. One or more of the multiple processors may be coupled with one or more of the multiple memories, which may, individually or collectively, be configured to perform various functions herein. In some examples, the at least one processor 1235 may be a component of a processing system, which may refer to a system (such as a series) of machines, circuitry (including, for example, one or both of processor circuitry (which may include the at least one processor 1235) and memory circuitry (which may include the at least one memory 1225)), or components, that receives or obtains inputs and processes the inputs to produce, generate, or obtain a set of outputs. The processing system may be configured to perform one or more of the functions described herein. For example, the at least one processor 1235 or a processing system including the at least one processor 1235 may be configured to, configurable to, or operable to cause the device 1205 to perform one or more of the functions described herein. Further, as described herein, being “configured to,” being “configurable to,” and being “operable to” may be used interchangeably and may be associated with a capability, when executing code stored in the at least one memory 1225 or otherwise, to perform one or more of the functions described herein.

In some examples, a bus 1240 may support communications of (e.g., within) a protocol layer of a protocol stack. In some examples, a bus 1240 may support communications associated with a logical channel of a protocol stack (e.g., between protocol layers of a protocol stack), which may include communications performed within a component of the device 1205, or between different components of the device 1205 that may be co-located or located in different locations (e.g., where the device 1205 may refer to a system in which one or more of the communications manager 1220, the transceiver 1210, the at least one memory 1225, the code 1230, and the at least one processor 1235 may be located in one of the different components or divided between different components).

In some examples, the communications manager 1220 may manage aspects of communications with a core network 130 (e.g., via one or more wired or wireless backhaul links). For example, the communications manager 1220 may manage the transfer of data communications for client devices, such as one or more UEs 115. In some examples, the communications manager 1220 may manage communications with one or more other network entities 105, and may include a controller or scheduler for controlling communications with UEs 115 (e.g., in cooperation with the one or more other network devices). In some examples, the communications manager 1220 may support an X2 interface within an LTE/LTE-A wireless communications network technology to provide communication between network entities 105.

The communications manager 1220 may support wireless communications in accordance with examples as disclosed herein. For example, the communications manager 1220 is capable of, configured to, or operable to support a means for receiving a random access request from a UE. The communications manager 1220 is capable of, configured to, or operable to support a means for transmitting, to the UE, a random access response that provides an indication of an uplink grant for an uplink message subsequent to the random access request, the uplink grant including at least a first uplink resource for a random access message and a second uplink resource for a scheduling request. The communications manager 1220 is capable of, configured to, or operable to support a means for monitoring the first uplink resource for the random access message and the second uplink resource for the scheduling request.

By including or configuring the communications manager 1220 for operation in the device 1205 as described herein, may support techniques for indication of one or more UE features in a random access procedure, with reduced overhead associated with PRACH resources, that provides for reduced power consumption and enhanced reliability, quality, and latency.

In some examples, the communications manager 1220 may be configured to perform various operations (e.g., receiving, obtaining, monitoring, outputting, transmitting) using or otherwise in cooperation with the transceiver 1210, the one or more antennas 1215 (e.g., where applicable), or any combination thereof. Although the communications manager 1220 is illustrated as a separate component, in some examples, one or more functions described with reference to the communications manager 1220 may be supported by or performed by the transceiver 1210, one or more of the at least one processor 1235, one or more of the at least one memory 1225, the code 1230, or any combination thereof (for example, by a processing system including at least a portion of the at least one processor 1235, the at least one memory 1225, the code 1230, or any combination thereof). For example, the code 1230 may include instructions executable by one or more of the at least one processor 1235 to cause the device 1205 to perform various aspects of techniques for random access in wireless communications as described herein, or the at least one processor 1235 and the at least one memory 1225 may be otherwise configured to, individually or collectively, perform or support such operations.

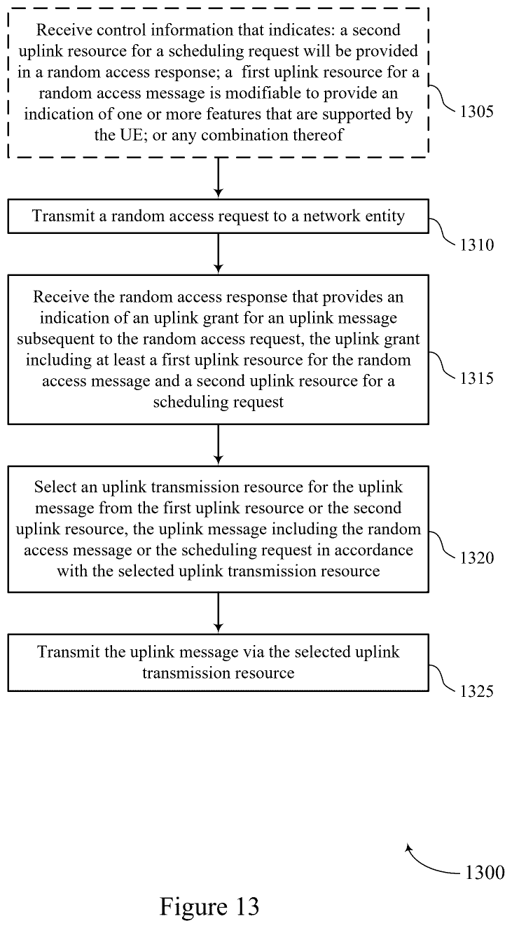

FIG. 13 shows a flowchart illustrating a method 1300 that supports techniques for random access in wireless communications in accordance with one or more aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

Optionally, at 1305, the method may include receiving control information that indicates: a second uplink resource for a scheduling request will be provided in a random access response; a first uplink resource is modifiable to provide an indication of one or more features that are supported by the UE; or any combination thereof. In some examples, aspects of the operations of 1305 may be performed by a control information component 750.

At 1310, the method may include transmitting a random access request to a network entity. In some examples, aspects of the operations of 1310 may be performed by a random access request component 725.

At 1315, the method may include receiving the random access response that provides an indication of an uplink grant for an uplink message subsequent to the random access request, the uplink grant including at least a first uplink resource for the random access message and a second uplink resource for a scheduling request. In some examples, aspects of the operations of 1315 may be performed by a random access response component 730.

At 1320, the method may include selecting an uplink transmission resource for the uplink message from the first uplink resource or the second uplink resource, the uplink message including the random access message or the scheduling request in accordance with the selected uplink transmission resource. In some examples, aspects of the operations of 1320 may be performed by an uplink resource selection component 735.

At 1325, the method may include transmitting the uplink message via the selected uplink transmission resource. In some examples, aspects of the operations of 1325 may be performed by an uplink transmission component 740.

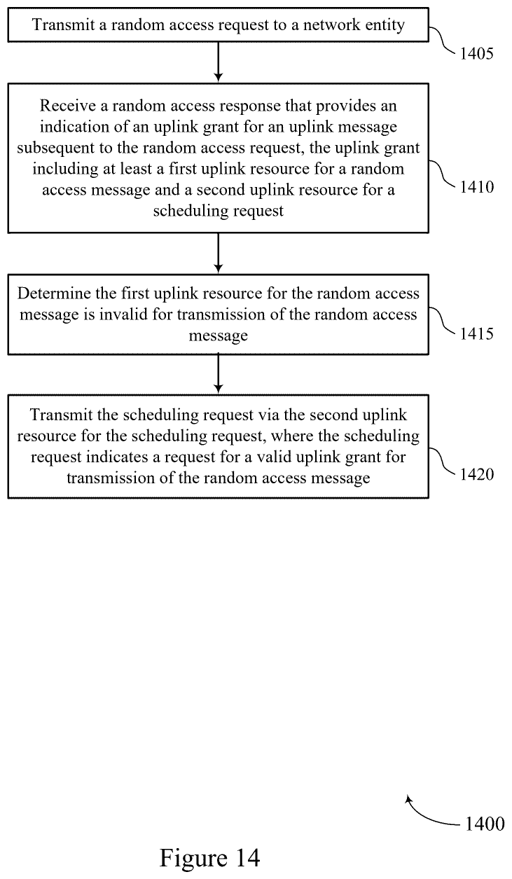

FIG. 14 shows a flowchart illustrating a method 1400 that supports techniques for random access in wireless communications in accordance with one or more aspects of the present disclosure. The operations of the method 1400 may be implemented by a UE or its components as described herein. For example, the operations of the method 1400 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1405, the method may include transmitting a random access request to a network entity. In some examples, aspects of the operations of 1405 may be performed by a random access request component 725.

At 1410, the method may include receiving a random access response that provides an indication of an uplink grant for an uplink message subsequent to the random access request, the uplink grant including at least a first uplink resource for a random access message and a second uplink resource for a scheduling request. In some examples, aspects of the operations of 1410 may be performed by a random access response component 730.

At 1415, the method may include determining the first uplink resource for the random access message is invalid for transmission of the random access message. In some examples, aspects of the operations of 1415 may be performed by an uplink resource selection component 735.

At 1420, the method may include transmitting the scheduling request via the second uplink resource for the scheduling request, where the scheduling request indicates a request for a valid uplink grant for transmission of the random access message. In some examples, aspects of the operations of 1420 may be performed by an uplink resource selection component 735.

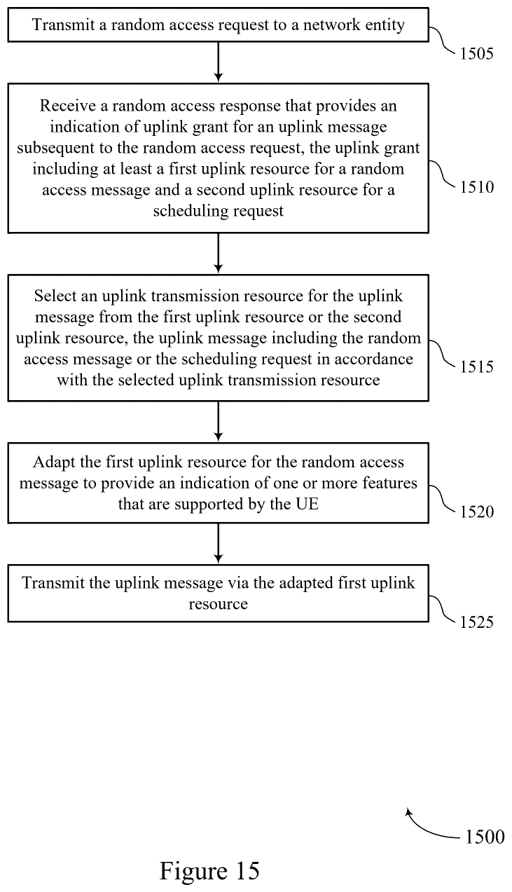

FIG. 15 shows a flowchart illustrating a method 1500 that supports techniques for random access in wireless communications in accordance with one or more aspects of the present disclosure. The operations of the method 1500 may be implemented by a UE or its components as described herein. For example, the operations of the method 1500 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1505, the method may include transmitting a random access request to a network entity. In some examples, aspects of the operations of 1505 may be performed by a random access request component 725.

At 1510, the method may include receiving a random access response that provides an indication of an uplink grant for an uplink message subsequent to the random access request, the uplink grant including at least a first uplink resource for a random access message and a second uplink resource for a scheduling request. In some examples, aspects of the operations of 1510 may be performed by a random access response component 730.

At 1515, the method may include selecting an uplink transmission resource for the uplink message from the first uplink resource or the second uplink resource, the uplink message including the random access message or the scheduling request in accordance with the selected uplink transmission resource. In some examples, aspects of the operations of 1515 may be performed by an uplink resource selection component 735.

At 1520, the method may include adapting the first uplink resource for the random access message to provide an indication of one or more features that are supported by the UE. In some examples, aspects of the operations of 1520 may be performed by an uplink resource adaptation component 745.

At 1525, the method may include transmitting the uplink message via the adapted first uplink resource. In some examples, aspects of the operations of 1525 may be performed by an uplink transmission component 740.

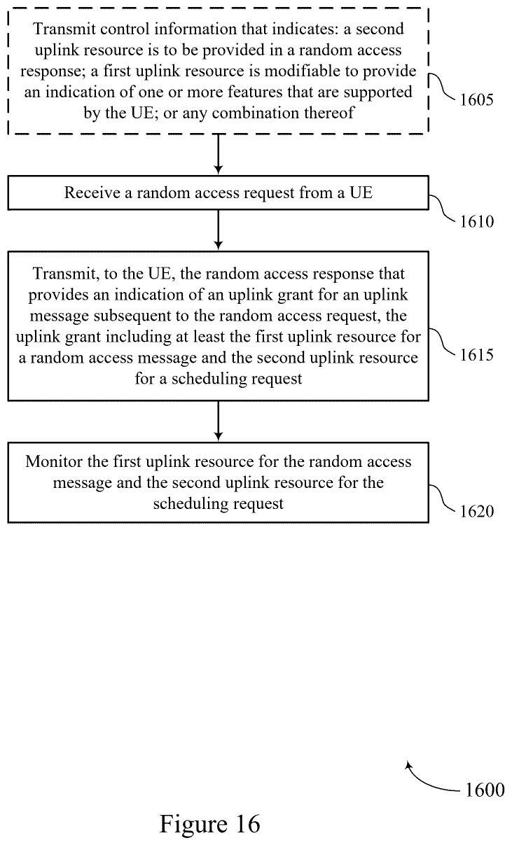

FIG. 16 shows a flowchart illustrating a method 1600 that supports techniques for random access in wireless communications in accordance with one or more aspects of the present disclosure. The operations of the method 1600 may be implemented by a network entity or its components as described herein. For example, the operations of the method 1600 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

Optionally, at 1605, the method may include transmitting control information that indicates: a second uplink resource is to be provided in a random access response; a first uplink resource is modifiable to provide an indication of one or more features that are supported by the UE; or any combination thereof. In some examples, aspects of the operations of 1605 may be performed by a control information component 1150.

At 1610, the method may include receiving a random access request from a UE. In some examples, aspects of the operations of 1610 may be performed by a random access request component 1125.

At 1615, the method may include transmitting, to the UE, the random access response that provides an indication of an uplink grant for an uplink message subsequent to the random access request, the uplink grant including at least the first uplink resource for a random access message and the second uplink resource for a scheduling request. In some examples, aspects of the operations of 1615 may be performed by a random access response component 1130.

At 1620, the method may include monitoring the first uplink resource for the random access message and the second uplink resource for the scheduling request. In some examples, aspects of the operations of 1620 may be performed by an uplink transmission component 1135.

The following provides an overview of aspects of the present disclosure:

Aspect 1: A method for wireless communications at a UE, comprising: transmitting a random access request to a network entity; receiving a random access response that provides an indication of uplink grant for an uplink message subsequent to the random access request, the uplink grant including at least a first uplink resource for a random access message and a second uplink resource for a scheduling request; selecting an uplink transmission resource for the uplink message from the first uplink resource or the second uplink resource, the uplink message including the random access message or the scheduling request in accordance with the selected uplink transmission resource; and transmitting the uplink message via the selected uplink transmission resource.

Aspect 2: The method of aspect 1, wherein the selected uplink transmission resource is for the random access message when the first uplink resource for the random access message provides sufficient uplink resources to indicate one or more features that are supported by the UE.

Aspect 3: The method of aspect 1, further comprising: determining the first uplink resource for the random access message is invalid for transmission of the random access message; and transmitting the scheduling request via the second uplink resource for the scheduling request, wherein the scheduling request indicates a request for a valid uplink grant for transmission of the random access message.

Aspect 4: The method of aspect 1, wherein transmitting the uplink message comprises: adapting the first uplink resource for the random access message to provide an indication of one or more features that are supported by the UE; and transmitting the uplink message via the adapted first uplink resource.

Aspect 5: The method of aspect 4, wherein adapting the first uplink resource comprises one or more of: adapting a waveform for the random access message to be transmitted via the first uplink resource, puncturing one or more resource blocks of the first uplink resource, or puncturing one or more symbols of the first uplink resource.

Aspect 6: The method of any of aspects 1 through 5, further comprising: receiving control information that indicates the second uplink resource for the scheduling request is provided in the random access response, the first uplink resource is modifiable to provide an indication of one or more features that are supported by the UE, or any combination thereof.

Aspect 7: The method of aspect 6, wherein the control information is provided in one or more of system information, radio resource control signaling, or the random access response.

Aspect 8: The method of any of aspects 6 through 7, wherein the control information indicates one or more of a resource configuration for a scheduling request message associated with the second uplink resource, or one or more thresholds associated with selection of the first uplink resource or the second uplink resource for the uplink message.

Aspect 9: The method of any of aspects 6 through 8, wherein the control information indicates one or more adaptations available for the first uplink resource for transmission of the random access message, or one or more thresholds associated with selection of the first uplink resource or the second uplink resource for the uplink message, or any combination thereof.

Aspect 10: The method of any of aspects 1 through 9, wherein the uplink message includes the scheduling request and the uplink grant indicates control channel resources, and wherein the scheduling request includes a payload that indicates a type of grant that is requested by the UE or an identification associated with the UE.

Aspect 11: The method of any of aspects 1 through 10, wherein the uplink message includes the scheduling request that is transmitted using a waveform selected from a set of available waveforms that indicates one or more features associated with a type of grant that is requested by the UE.

Aspect 12: The method of any of aspects 1 through 11, wherein the random access response further indicates a timing advance value that is applied for transmission of the uplink message.

Aspect 13: The method of any of aspects 1 through 12, wherein the random access response further indicates the second uplink resource is active in accordance with one of a control information field of a control channel associated with the random access response, a medium access control (MAC) header field associated with a backoff indication, a MAC header field associated with a random access preamble identifier of the random access request, or an information field within the random access response.

Aspect 14: The method of any of aspects 1 through 13, wherein the random access response further indicates a timing offset associated with the second uplink resource, and wherein the timing offset is provided in a joint indication of a control channel and a shared channel associated with the random access response, or the timing offset is provided only in the shared channel associated with the random access response.

Aspect 15: The method of aspect 14, wherein the timing offset is between a last symbol of a shared channel associated with the random access response and an initial symbol of the second uplink resource, and corresponds to a time gap associated with a timing advance and a waveform preparation time associated with transmission of the scheduling request.

Aspect 16: The method of any of aspects 1 through 15, further comprising: initiating a timer responsive to transmission of the scheduling request via the second uplink resource, the timer providing a time window for monitoring for a subsequent uplink grant associated with the scheduling request.

Aspect 17: The method of any of aspects 1 through 16, wherein the indication of the uplink grant in the random access response indicates an ordered random access channel resource for early indication of multiple UE types.

Aspect 18: A method for wireless communications at a network entity, comprising: receiving a random access request from a UE; transmitting, to the UE, a random access response that provides an indication of an uplink grant for an uplink message subsequent to the random access request, the uplink grant including at least a first uplink resource for a random access message and a second uplink resource for a scheduling request; and monitoring the first uplink resource for the random access message and the second uplink resource for the scheduling request.

Aspect 19: The method of aspect 18, wherein the uplink message is received via the first uplink resource when the first uplink resource provides sufficient uplink resources for the UE to indicate one or more features that are supported by the UE.

Aspect 20: The method of aspect 18, further comprising: receiving the scheduling request via the second uplink resource, the scheduling request indicating a request for a subsequent uplink grant with sufficient resources for the UE to indicate one or more features that are supported by the UE.

Aspect 21: The method of aspect 18, further comprising: receiving the random access message via the first uplink resource, wherein the first uplink resource is adapted to provide an indication of one or more features that are supported by the UE.

Aspect 22: The method of aspect 21, wherein the first uplink resource is adapted to provide one or more of an adapted waveform for the random access message transmitted via the first uplink resource, one or more punctured resource blocks of the first uplink resource, or one or more punctured symbols of the first uplink resource.

Aspect 23: The method of any of aspects 18 through 22, further comprising: transmitting control information that indicates the second uplink resource is provided in the random access response, the first uplink resource is modifiable to provide an indication of one or more features that are supported by the UE, or any combination thereof.

Aspect 24: The method of aspect 23, wherein the control information is provided in one or more of system information, radio resource control signaling, or the random access response.

Aspect 25: The method of any of aspects 23 through 24, wherein the control information indicates one or more of a resource configuration for the scheduling request associated with the second uplink resource, or one or more thresholds associated with selection of the first uplink resource or the second uplink resource for the uplink message.

Aspect 26: The method of any of aspects 23 through 25, wherein the control information indicates one or more adaptations available for the second uplink resource for transmission of the random access message, or one or more thresholds associated with selection of the first uplink resource or the second uplink resource for the uplink message, or any combination thereof.

Aspect 27: The method of any of aspects 18 through 26, wherein the uplink message includes the scheduling request and the uplink grant indicates control channel resources, and wherein the scheduling request includes a payload that indicates a type of grant that is requested by the UE or an identification associated with the UE.

Aspect 28: The method of any of aspects 18 through 27, wherein the uplink message includes the scheduling request that is transmitted using a waveform selected from a set of available waveforms that indicates one or more features associated with a type of grant that is requested by the UE.

Aspect 29: The method of any of aspects 18 through 28, wherein the random access response further indicates a timing advance value that is to be applied for transmission of the uplink message.

Aspect 30: The method of any of aspects 18 through 29, wherein the random access response further indicates the second uplink resource is active in accordance with one of a control information field of a control channel associated with the random access response, a medium access control (MAC) header field associated with a backoff indication, a MAC header field associated with a random access preamble identifier of the random access request, or an information field within the random access response.

Aspect 31: The method of any of aspects 18 through 30, wherein the random access response further indicates a timing offset associated with the second uplink resource, and wherein the timing offset is provided in a joint indication of a control channel and a shared channel associated with the random access response, or the timing offset is provided only in the shared channel associated with the random access response.

Aspect 32: The method of aspect 31, wherein the timing offset is between a last symbol of a shared channel associated with the random access response and an initial symbol of the second uplink resource, and corresponds to a time gap associated with a timing advance and a waveform preparation time associated with transmission of the scheduling request.

Aspect 33: The method of any of aspects 18 through 32, wherein the indication of the uplink grant in the random access response indicates an ordered random access channel resource for early indication of multiple UE types.

Aspect 34: A UE for wireless communications, comprising a processing system that includes processor circuitry and memory circuitry that stores code, the processing system configured to cause the UE to perform a method of any of aspects 1 through 17.

Aspect 35: A UE for wireless communications, comprising at least one means for performing a method of any of aspects 1 through 17.

Aspect 36: A non-transitory computer-readable medium storing code for wireless communications, the code comprising instructions executable by one or more processors to perform a method of any of aspects 1 through 17.

Aspect 37: A network entity for wireless communications, comprising a processing system that includes processor circuitry and memory circuitry that stores code, the processing system configured to cause the network entity to perform a method of any of aspects 18 through 33.

Aspect 38: A network entity for wireless communications, comprising at least one means for performing a method of any of aspects 18 through 33.

Aspect 39: A non-transitory computer-readable medium storing code for wireless communications, the code comprising instructions executable by one or more processors to perform a method of any of aspects 18 through 33.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
transmit a random access request to a network entity;
receive a random access response that provides an indication of an uplink grant for an uplink message subsequent to the random access request, the uplink grant including at least a first uplink resource for a random access message and a second uplink resource for a scheduling request;
select an uplink transmission resource for the uplink message from the first uplink resource or the second uplink resource, the uplink message including the random access message or the scheduling request in accordance with the selected uplink transmission resource; and
transmit the uplink message via the selected uplink transmission resource.

2. The UE of claim 1, wherein the selected uplink transmission resource is for the random access message when the first uplink resource for the random access message provides sufficient uplink resources to indicate one or more features that are supported by the UE.

3. The UE of claim 1, wherein the one or more processors are individually or collectively further operable to execute the code to cause the UE to:
determine the first uplink resource for the random access message is invalid for transmission of the random access message; and
transmit the scheduling request via the second uplink resource for the scheduling request, wherein the scheduling request indicates a request for a valid uplink grant for transmission of the random access message.

4. The UE of claim 1, wherein, to transmit the uplink message, the one or more processors are individually or collectively operable to execute the code to cause the UE to:
adapt the first uplink resource for the random access message to provide an indication of one or more features that are supported by the UE; and
transmit the uplink message via the adapted first uplink resource.

5. The UE of claim 4, wherein the one or more processors are individually or collectively operable to execute the code to cause the UE to:
adapt a waveform for the random access message to be transmitted via the first uplink resource,
puncture one or more resource blocks of the first uplink resource, or
puncture one or more symbols of the first uplink resource.

6. The UE of claim 1, wherein the one or more processors are individually or collectively further operable to execute the code to cause the UE to:
receive control information that indicates the second uplink resource for the scheduling request is provided in the random access response, the first uplink resource is modifiable to provide an indication of one or more features that are supported by the UE, or any combination thereof.

7. The UE of claim 6, wherein the control information is provided in one or more of system information, radio resource control signaling, or the random access response.

8. The UE of claim 6, wherein the control information indicates one or more of a resource configuration for a scheduling request message associated with the second uplink resource, or one or more thresholds associated with selection of the first uplink resource or the second uplink resource for the uplink message.

9. The UE of claim 6, wherein the control information indicates one or more adaptations available for the first uplink resource for transmission of the random access message, or one or more thresholds associated with selection of the first uplink resource or the second uplink resource for the uplink message, or any combination thereof.

10. The UE of claim 1, wherein the uplink message includes the scheduling request and the uplink grant indicates control channel resources, and wherein the scheduling request includes a payload that indicates a type of grant that is requested by the UE or an identification associated with the UE.

11. The UE of claim 1, wherein the uplink message includes the scheduling request that is transmitted using a waveform selected from a set of available waveforms that indicates one or more features associated with a type of grant that is requested by the UE.

12. The UE of claim 1, wherein the random access response further indicates a timing advance value that is applied for transmission of the uplink message.

13. The UE of claim 1, wherein the random access response further indicates the second uplink resource is active in accordance with one of a control information field of a control channel associated with the random access response, a medium access control (MAC) header field associated with a backoff indication, a MAC header field associated with a random access preamble identifier of the random access request, or an information field within the random access response.

14. The UE of claim 1, wherein the random access response further indicates a timing offset associated with the second uplink resource, and wherein the timing offset is provided in a joint indication of a control channel and a shared channel associated with the random access response, or the timing offset is provided only in the shared channel associated with the random access response.

15. The UE of claim 14, wherein the timing offset is between a last symbol of a shared channel associated with the random access response and an initial symbol of the second uplink resource, and corresponds to a time gap associated with a timing advance and a waveform preparation time associated with transmission of the scheduling request.

16. The UE of claim 1, wherein the one or more processors are individually or collectively further operable to execute the code to cause the UE to:
initiate a timer responsive to transmission of the scheduling request via the second uplink resource, the timer providing a time window for monitoring for a subsequent uplink grant associated with the scheduling request.

17. The UE of claim 1, wherein the indication of the uplink grant in the random access response indicates an ordered random access channel resource for early indication of multiple UE types.

18. A network entity, comprising:
one or more memories storing processor-executable code; and
one or more processors coupled with the one or more memories and individually or collectively operable to execute the code to cause the network entity to:
receive a random access request from a user equipment (UE);
transmit, to the UE, a random access response that provides an indication of an uplink grant for an uplink message subsequent to the random access request, the uplink grant including at least a first uplink resource for a random access message and a second uplink resource for a scheduling request; and
monitor the first uplink resource for the random access message and the second uplink resource for the scheduling request.

19. The network entity of claim 18, wherein the uplink message is received via the first uplink resource when the first uplink resource provides sufficient uplink resources for the UE to indicate one or more features that are supported by the UE.

20. The network entity of claim 18, wherein the one or more processors are individually or collectively further operable to execute the code to cause the network entity to:
receive the random access message via the first uplink resource, wherein the first uplink resource is adapted to provide an indication of one or more features that are supported by the UE.

21. The network entity of claim 18, wherein the one or more processors are individually or collectively further operable to execute the code to cause the network entity to:
transmit control information that indicates the second uplink resource is provided in the random access response, the first uplink resource is modifiable to provide an indication of one or more features that are supported by the UE, or any combination thereof.

22. The network entity of claim 18, wherein the uplink message includes the scheduling request and the uplink grant indicates control channel resources, and wherein the scheduling request includes a payload that indicates a type of grant that is requested by the UE or an identification associated with the UE.

23. A method for wireless communications at a user equipment (UE), comprising:
transmitting a random access request to a network entity;
receiving a random access response that provides an indication of an uplink grant for an uplink message subsequent to the random access request, the uplink grant including at least a first uplink resource for a random access message and a second uplink resource for a scheduling request;
selecting an uplink transmission resource for the uplink message from the first uplink resource or the second uplink resource, the uplink message including the random access message or the scheduling request in accordance with the selected uplink transmission resource; and
transmitting the uplink message via the selected uplink transmission resource.

24. The method of claim 23, wherein transmitting the uplink message comprises:
adapting the first uplink resource for the random access message to provide an indication of one or more features that are supported by the UE; and
transmitting the uplink message via the adapted first uplink resource.

25. The method of claim 24, wherein adapting the first uplink resource comprises one or more of:
adapting a waveform for the random access message to be transmitted via the first uplink resource,
puncturing one or more resource blocks of the first uplink resource, or
puncturing one or more symbols of the first uplink resource.

26. The method of claim 23, wherein the uplink message includes the scheduling request and the uplink grant indicates control channel resources, and wherein the scheduling request includes a payload that indicates a type of grant that is requested by the UE or an identification associated with the UE.

27. The method of claim 23, wherein the random access response further indicates the second uplink resource is active in accordance with one of a control information field of a control channel associated with the random access response, a medium access control (MAC) header field associated with a backoff indication, a MAC header field associated with a random access preamble identifier of the random access request, or an information field within the random access response.

28. A method for wireless communications at a network entity, comprising:
receiving a random access request from a user equipment (UE);
transmitting, to the UE, a random access response that provides an indication of an uplink grant for an uplink message subsequent to the random access request, the uplink grant including at least a first uplink resource for a random access message and a second uplink resource for a scheduling request; and
monitoring the first uplink resource for the random access message and the second uplink resource for the scheduling request.

29. The method of claim 28, further comprising:
receiving the scheduling request via the second uplink resource, the scheduling request indicating a request for a subsequent uplink grant with sufficient resources for the UE to indicate one or more features that are supported by the UE.

30. The method of claim 28, further comprising:
receiving the random access message via the first uplink resource, wherein the first uplink resource is adapted to provide an indication of one or more features that are supported by the UE.
